(19) United States
(12) Patent Application Publication
(10) Pub. No.: US 2011/0256517 A1
(43) Pub. Date: Oct. 20, 2011

(54) COMPUTER AIDED REAL-TIME BEHAVIOR COACHING

(76) Inventor: Alaster Drew Swanson, Houston, TX (US)

(21) Appl. No.: 13/089,359

(22) Filed: Apr. 19, 2011

Related U.S. Application Data
(60) Provisional application No. 61/325,960, filed on Apr. 20, 2010.

(51) Int. Cl. G09B 19/00

(52) U.S. Cl. 434/236

(57) ABSTRACT

Computer implemented methods and systems for coaching a person by coaching, guiding, or training a person is provided. Accordingly, a coaching protocol is accessed for coaching a person in real-time to engage in a predetermined behavior; a message is sent in real-time to the person to execute the one of the plurality of behavior-steps; wherein the coaching protocol includes a plurality of behavior-steps, wherein the execution of one of the plurality of behavior-steps by the person results in the person engaging in the predetermined behavior. In addition, data can be gathered and based on gathered data, a determination can be made whether to modify the coaching protocol, and accordingly, the coaching protocol may be modified.

### CROSS-REFERENCE TO RELATED APPLICATIONS

This application claims priority from a provisional application titled “Computer Aided Real-Time Behavior Coaching” by Alaster Drew Swanson, file on Apr. 20, 2010, U.S. Ser. No. 61/325,960, which is hereby incorporated in its entirety by reference.

### TECHNICAL FIELD

The subject matter is generally related to computer aided coaching.

### BACKGROUND

In some human endeavors, sometimes one person coaches, trains, or guides another person or other persons to learn or master new skills or behaviors, improve old ones, or help them step through a set of steps that may be difficult to follow because of their complexity, novelty, or personal anxieties. Coaching, guiding, or training can be quite expensive. Every year, individuals, government agencies, businesses, and other private and public organizations spend millions for such coaching, guidance, and training, both for personal or professional purposes. The major portion of the monies spent involves finding and paying qualified persons to coach, train, or guide other people. In addition, because of the expense, organizations sometimes have to cap or forgo coaching, training, or guiding individuals who may have difficulty but who may with persistence become valuable members of the organizations.

### SUMMARY

Computer implemented methods and systems for coaching a person are presented herein. In one embodiment, a computer-implemented method for coaching, guiding, or training a person is provided. According to this method, a coaching protocol is accessed for coaching a person in real-time to engage in a predetermined behavior; a message is sent in real-time to the person to execute the one of the plurality of behavior-steps; wherein the coaching protocol includes a plurality of behavior-steps, wherein the execution of one of the plurality of behavior-steps by the person results in the person engaging in the predetermined behavior.

In addition, data can be gathered and based on the gathered data, a determination can be made whether to modify the coaching protocol. Accordingly, the coaching protocol may be modified.

Furthermore, a second message may be sent in real-time to the person to execute a second one of the plurality of behavior-steps. Prior to sending the second message, a message may be from the person prior to the sending of the second message, wherein the second message is sent in response to the received message from the person and based on the response, the second one the plurality of behavior-steps to be executed next by the person is selected. The message received from the person may include information regarding the execution of the one of the plurality of behavior-steps. Based on the information in the message received from the person, the coaching protocol may be modified. Such modification may for example include modifying one of the of behavior-steps in the coaching protocol or adding a new step to the plurality of behavior-steps.

In another aspect, the coaching protocol may include another plurality of behavior-steps for execution by at least one other person and at least one other message is sent in real-time to the at least one other person to execute one of the another plurality of behavior-steps. The execution of one of the plurality of behavior-steps by the person and the execution of the another plurality of behavior-steps by the at least one other person results in execution of the predetermined behavior by the person and the at least one other person. In some instances, the at least one other message is sent after receiving a message from the first person and after it is determined based on that message from the person whether to send the at least one other message.

In yet another aspect, the method further includes receiving information on the predetermined behavior and generating, based on the data, the coaching protocol. The coaching protocol may be generated by selecting, based on the information on the predetermined behavior, among sets of predefined behavior-steps, at least one set of behavior-steps to generate the coaching protocol. Information may be received defining at least one behavior step to be included in the coaching protocol by, for example, presenting a question in response to which the information is received.

The messages may be text messages, email messages, automated phone calls, instant messages, or any other type of real-time messages sent over a network. A first message may be sent over a network, wherein the message includes a query. A message sent back by the coached person in response may be received and that message may be parsed to determine the response of the person to the query. The message that was sent to the person may include at least one predefined response to the query and parsing the response message includes analyzing the second message to detect the predefined response. Based on the response, it may then be determined to take further steps, such as whether to notify a second person, change the coaching protocol, or select another behavior step in the coaching protocol.

The coaching protocol may be generated based on information regarding a sales opportunity, information regarding periodic goals for the individual, or information regarding compliance with a legal regulatory regime.

In another aspect, a computer system is presented which includes means for accessing a coaching protocol for coaching a person in real-time to engage in a predetermined behavior and means for sending in real-time a message to the person to execute the one of the plurality of behavior-steps, wherein the coaching protocol comprises a plurality of behavior-steps, wherein the execution of one of the plurality of behavior-steps by the person results in the person engaging in the predetermined behavior.

In yet another aspect, a computer system is presented which at least one processor and a machine readable medium storing a computer program, wherein the computer program comprises machine-readable instructions for the computer system to execute a computer-implemented method that includes the steps of accessing a coaching protocol for coaching a person in real-time to engage in a predetermined behavior comprising a plurality of behavior-steps and sending in real-time a message to the person to execute the one of the plurality of behavior-steps, wherein the coaching protocol comprises a plurality of behavior-steps, wherein the execution of one of the plurality of behavior-steps by the person results in the person engaging in the predetermined behavior.

In yet another aspect, a machine-readable medium storing a computer program comprising machine-readable instructions for a computer system to execute a computer-implemented method is presented, wherein the method includes steps of accessing a coaching protocol for coaching a person in real-time to engage in a predetermined behavior and sending in real-time a message to the person to execute the one of the plurality of behavior-steps, wherein the coaching protocol comprises a plurality of behavior-steps, wherein the execution of one of the plurality of behavior-steps by the person results in the person engaging in the predetermined behavior.

In still another aspect, a computer implemented method and system is presented wherein machine-readable instructions for a computer system to execute a computer-implemented method are transmitted over a network, wherein the machine-readable instructions comprise a computer program for accessing a coaching protocol for coaching a person in real-time to engage in a predetermined behavior and sending in real-time a message to the person to execute the one of the plurality of behavior-steps, wherein the coaching protocol comprises a plurality of behavior-steps, wherein the execution of one of the plurality of behavior-steps by the person results in the person engaging in the predetermined behavior.

Some embodiments presented herein leverage Real-Time Communication Tools (RTCTs) in an automated fashion to engage a user on specific tasks at specific times. These sessions will be guided by pre-defined workflows that have different levels of interactivity depending on the task. Some task will require specific step by step guidance while others will be more open and broad. The goal again is to engage the client, using RTCT, in focused intervals of work that provides real-time feedback. The system will also track how the engagements are doing over time to track progress and identify areas or further improvement. Different embodiments include different advantages. These advantages include: a zero learning curve interface since if the user can respond to text messages or instant message, the user can be automatically coached, trained, or guided; active pursuing of date whereby the user is asked pro-actively, and perhaps persistently if needed, to enter data; as users are busy and often get sidetracked, users are pro-actively pursued by messages to execute on what they need to do and are pushed to engage best practices; easy adaptability for various purposes including sales coach, drug therapy coach, new employee coach, book contents coach, six-sigma coach, lead generation, regulatory compliance, supplemental to in class training by pro-actively coaching users through implementation of such training, and so on. Some embodiments can be cloud based and easily customizable thereby making training, such as executive and sales coaching, inexpensive as it is implemented by computers and can be cloud based allowing it be affordable and widely deployable.

### BRIEF DESCRIPTION OF THE DRAWINGS

FIG. 1 shows a schematic diagram of an embodiment of a computer system for coaching users.

FIG. 2 shows a schematic diagram of an embodiment of the coaching computer of the computer system in FIG. 1.

FIG. 3 shows a schematic diagram of an embodiment of a server of the coaching computer in FIG. 2.

FIG. 4 shows a flowchart of an embodiment of a coaching program.

FIG. 5 is a flowchart of an embodiment of a computer software subprogram to carry out the generating step shown in FIG. 4

FIG. 5A shows an embodiment of a graphical user interface for creating a user account for a user to be coached by a coaching computer.

FIGS. 5B and 5C show embodiments of graphical user interfaces for creating a coaching protocol for a user.

FIG. 5D shows an embodiment of a graphical user interface for modifying and/or creating coaching protocols.

FIG. 5E is an embodiment of a report on a sales opportunity.

FIG. 5F shows an embodiment of step-blocks of a coaching protocol.

FIG. 6 is a flow chart of an embodiment of a computer subprogram to carry out the coaching step in FIG. 4.

FIG. 6A is an example of a coaching instant message.

FIG. 6B is a flowchart of an alternative embodiment of a computer software subprogram to carry out the coaching step in FIG. 4.

FIG. 6C shows an example of a graphical user interface used by a thin client to coach user.

FIG. 7 is a flowchart of an embodiment of a computer software subprogram to carry out the analyzing step in FIG. 4.

FIG. 8 is an example of a sales coaching protocol.

FIGS. 9 and 10 are two examples of flowcharts of coaching protocol.

FIG. 11 is a flow chart of an example of a coaching protocol for coaching people to take medication.

FIG. 12 is a flow chart of an example of a coaching protocol for reinforcing training after completion of in-class training.

FIG. 13 is a flow chart of an example of a coaching protocol for coaching a person through recommendations of a self help book.

FIG. 14 is a flow chart of an example of a coaching protocol in the area of human resource performance.

FIG. 15 is a flow chart of an example of a coaching protocol to provide real-time guidance to veterans.

FIG. 16 is a flow chart of an example of a coaching protocol for a business to communicate with its clients.

FIGS. 17, 18A-D, and 19 are examples of various coaching protocols.

FIGS. 20A-E show examples of graphical user interfaces of a script generation engine.

FIG. 21 shows an example of a graphical user interface for interacting and inputting data into a consequence engine.

### DETAILED DESCRIPTION

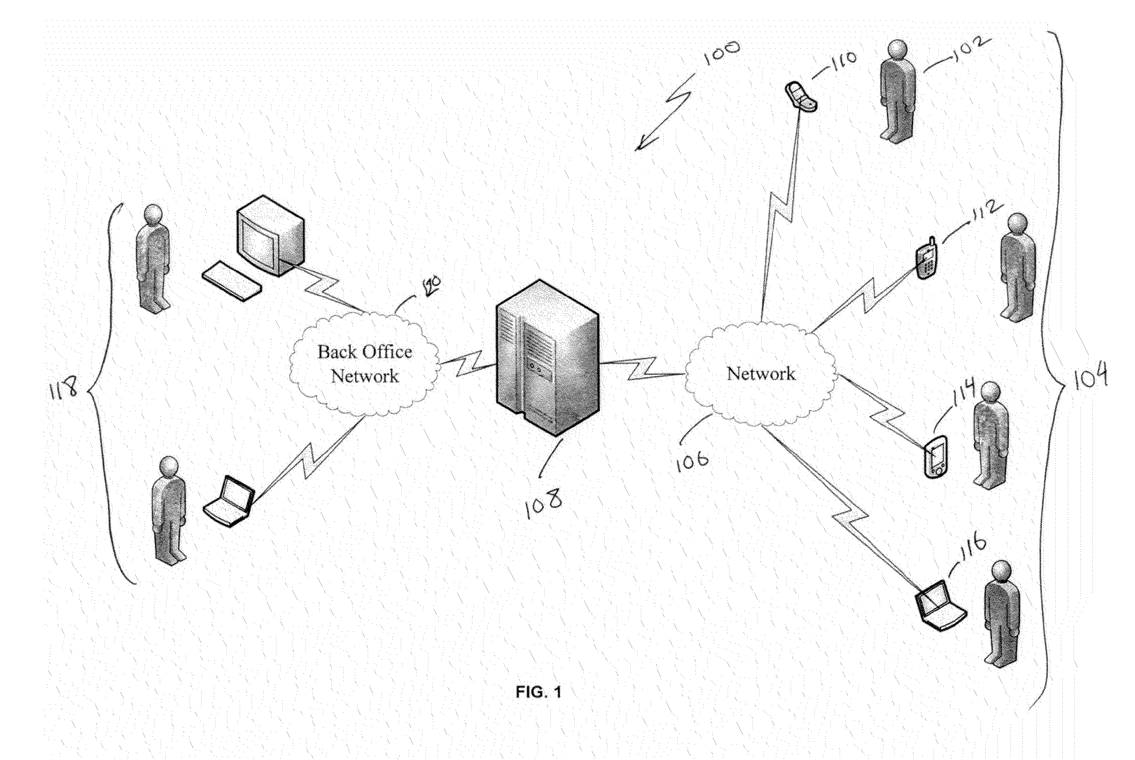

FIG. 1 shows a schematic diagram of an embodiment of a computer system 100 for remotely and automatically coaching a user 102 according to a predefined coaching protocol to perform at least one behavior set out in the coaching protocol. Computer system 100 may multiple users 104 according to various coaching protocols. Users 104 and/or user 102 are connected via a network 106 to a coaching computer 108. Hereinafter, the terms user 102 and users 104 will be used interchangeably and their use should not be construed to be a limiting factor in anyway. Network 106 may be the World Wide Web or the Internet, an intranet, a network of a telecommunication service provider, or any other type of network, specially a network capable of communicating with users 104 or user 102 in real-time, or any combination of the networks above as would easily be apparent to a person skilled in the arts. Coaching computer 108 communicates with each one of users 104 in real-time using a device such as a cell phone 110, a smart phone 112, a PDA 114, a net book or laptop computer 116, or various other computing devices capable of communicating in real-time through a network including tablet computers such as those marketed under the trademarks IPAD and Android tablets. Coaching computer 108 is also connected to one or more users 118 via a back-office network 120, here an intranet. In some embodiments networks 106 and 120 are one and the same or at least share some components. Users 118 may be persons who supervise user 102 or users 104, program and maintain coaching computer 108, or set up coaching protocols to be used by coaching computer 108 to coach user 102 or users 104.

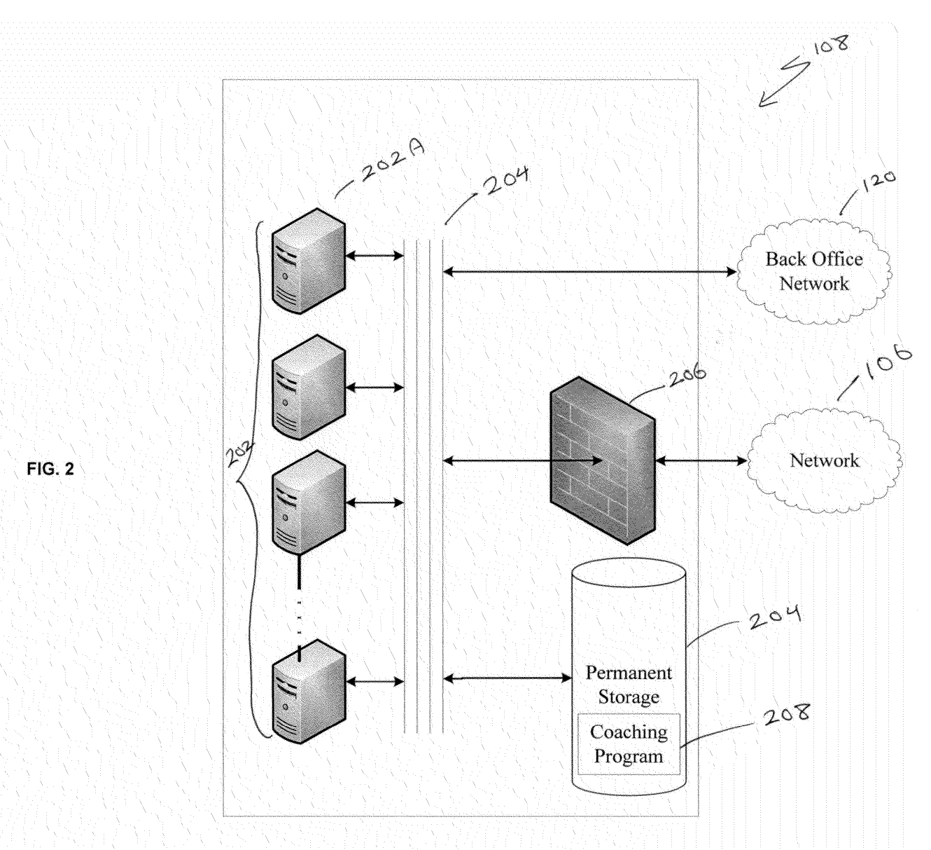

FIG. 2 shows a schematic diagram of an embodiment of coaching computer 108. Coaching computer 108 in this embodiment comprises multiple server computers 202 each connected to a bus or a network 204, through which server computers 202 can connect to a permanent storage 204, network 120, or network 106 via a firewall 206. Permanent storage 204 stores a coaching program 208 which is executed by at least one of the servers 202A. It should be noted that coaching computer 108 can be implemented using various other computer hardware and software architectures that would be easily apparent to a person skilled in the arts, such computer hardware architectures including shared server farms, cloud computing, or even a single server computer.

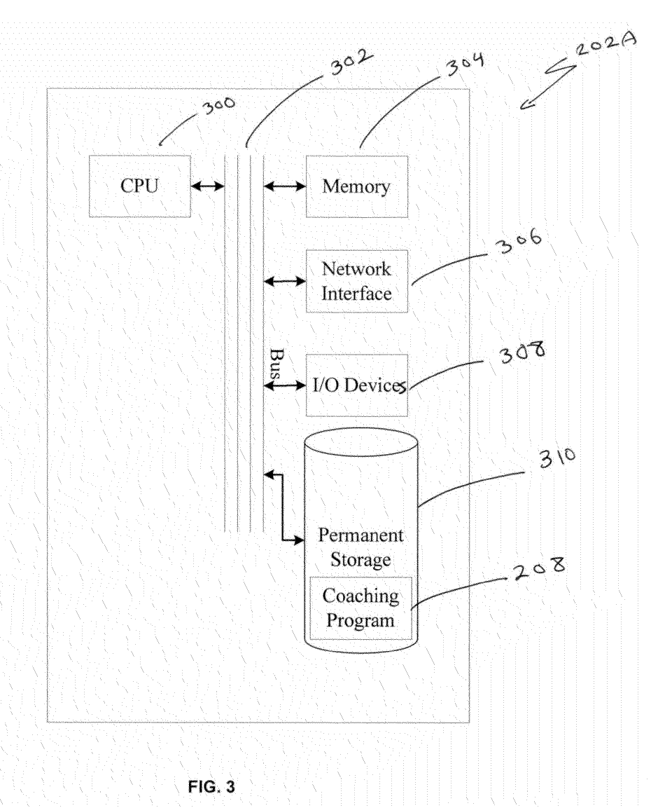

FIG. 3 shows a schematic diagram of server 202A. Server 202A includes a central processing Unit (CPU) 300, an internal bus 302, volatile memory 304, a network interface 306, one or more I/O devices 308, and a permanent storage 310 that may store a copy of coaching program 208. As would easily be apparent to the person skilled in the arts, server 202A may be implemented in other hardware configurations.

Coaching program 208 is a computer program that when run by CPU 300 communicates in real-time with user 102 and coaches user 102 in real-time to execute one or more behaviors. The term “coaching” herein includes pro-actively managing user 102's behaviors, guiding user 102 through various behaviors, encouraging user 102 to perform certain behaviors, evaluating the performance of user 102, and other activities normally associated with pro-actively engaging and coaching an individual by another individual. It should be noted that the computer-implemented coaching program and system described herein can be used to supplement and/or be supplemented by coaching by a person. The term “real-time” herein includes the meaning that an event takes place on or about the same time as when user 102 is to be coached or is being coached in accordance with a coaching protocol by coaching computer 108. The term “coaching program” herein includes a computer program stored in computer-readable format and implemented by coaching computer 108 wherein coaching computer 108 upon executing the coaching program communicates with user 102 in real-time and coaches user 102 to perform one or more of a plurality of behavior steps set out in a coaching protocol.

The term “coaching protocol” herein includes a workflow or a series of behavior steps that when executed by user 102 results in user 102 performing a predefined behavior. Coaching protocol may also include schedules for when the steps are to be performed, when coaching messages are to be sent to user 102, when data is to be gathered from user 102 or other sources, and/or when to expect messages from user 102, users 118, or other persons. Coaching messages may be real-time communication messages such as automated telephone calls using either pre-recorded messages or messages using computer generated voice, instant messages, emails, text messages such as SMS, or any other type of message sent over a network in real-time. In short, a coaching protocol can include a flow chart of behavior steps to be followed by user 102, information as to when the user is to be contacted with respect to each step, the manner in which the user is to be contacted, when to expect a response from the user, when and where to gather additional data from the user or other sources including third parties, goals to be met by the user and consequences for meeting or not meeting those goals (rewards and punishments, as appropriate), under what circumstances to have the coaching protocol modified by coaching program 208 or a human user whether it be user 102 or another person including users 118, or some combination of the above elements and/or other elements that would assist with coaching user 102.

Preferably, the behavior steps in a coaching protocol are designed to generally adhere to the following principles: (a) the predefined behavior is broken down to a series of small, digestible component behaviors which can be completed in a short, predetermined time period and which allow user 102 to engage in focused hard work for short periods; (b) the component behavior allow for easy assessment after its completion and for immediate and actionable feedback and coaching to be provided to user 102 to improve his or her performance.

To put it in another way, the methodology embodied in a coaching protocol is based on the idea that expert performance is more a result of training techniques than of innate ability or amount of time spent training. Therefore, a coaching protocol is created by taking a complex desired behavior or a desired outcome and determining behavior steps that when performed by user 102 results in user 102 ultimately performing the desired behavior or achieve the desired outcome with the goal of increasing success, efficiency, and continual improvement of the user's performance. Hence, a behavior step in a coaching protocol can have one, some, or all of the following characteristics: (1) demanding full attention for brief intervals; (2) Conducting frequent tests and providing immediate feedback against a clear standard; and/or (3) breaking mastery into mini goals.

Accordingly, a behavior step at least defines a particular component behavior, that is, a behavior step, to be performed by user 102. In addition, a behavior step can include a time period within which the behavior is to be completed. Such a time period is preset and can in some instances last between a minute to an hour to a day or more depending on the complexity of the component behavior and/or the overall predefined behavior the coaching protocol is designed for. A behavior step may also include other elements such as a consequence if user 102 does not perform the behavior step properly. For example, a consequence may be: (a) to remind user 102 if the time period set for that behavior has passed; (b) to inquire whether to extend the time period to complete the behavior step; (c) to grade user 102's adherence or compliance with the behavior step in accordance with a predetermined set of standards; (d) to report compliance or noncompliance to user 102's supervisor; (e) another appropriate consequence; or (f) some combination of the above consequences.

The standards set for compliance or adherence may include: (a) whether user 102 completed the behavior step within the required time period; (b) the length of time user 102 took to complete the behavior step; (c) the outcome of user 102's performance of the behavior step; (d) comparison of such outcome with a predefined set of expected outcomes; (e) complete compliance, partial compliance, or total noncompliance with the requirements of the behavior step; (f) other appropriate standards; or (e) some combination of the above standards.

In one embodiment, coaching protocols have different levels of interactivity with users. The level of interactivity depends on the ultimate desired behavior or outcome and how to best achieve it. A coaching protocol may have one of two characteristics:

1. A Less Actively Guided Protocol: This is a protocol that provides broad guidance on completing a selected task. Such as time frame guidance and tracking personal Key Performance Indicators (KPI). The user will only be contacted a few times during this type of protocol; or

2. A More Actively Guided Protocol: This type of protocol is more interactive where the system is walking the client through the specific steps in a workflow. This will ensure capture of key data as well as be able to easily measure performance and provide guidance when improvements can be made.

In addition, each coaching protocol may have one of two additional characteristics:

1. User Initiated or Situational Guided Protocol: These types of protocols are initiated by the client or user 102 and involve a specific situation in which the client wants to conduct a protocol. A common use of this type of protocol is follow-up to a meeting or conference call when the client wants to capture both specific data and additional action items.

2. Third Party Initiated Guided Protocol: In this case, the protocol may be initiated by a person other than user 102, such as a back office user 118, a supervisor, another member of the organization or company for which user 102 works for, or another third party. Such protocols may be used to assist user 102 to be driven to meet a specific and potential time sensitive activity. An example might be a report that is due.

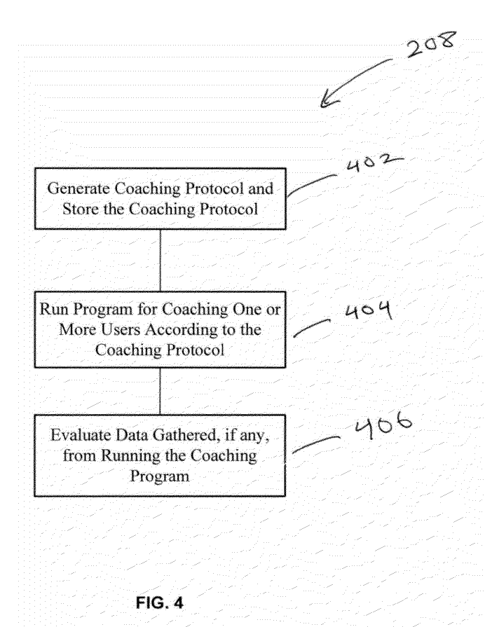

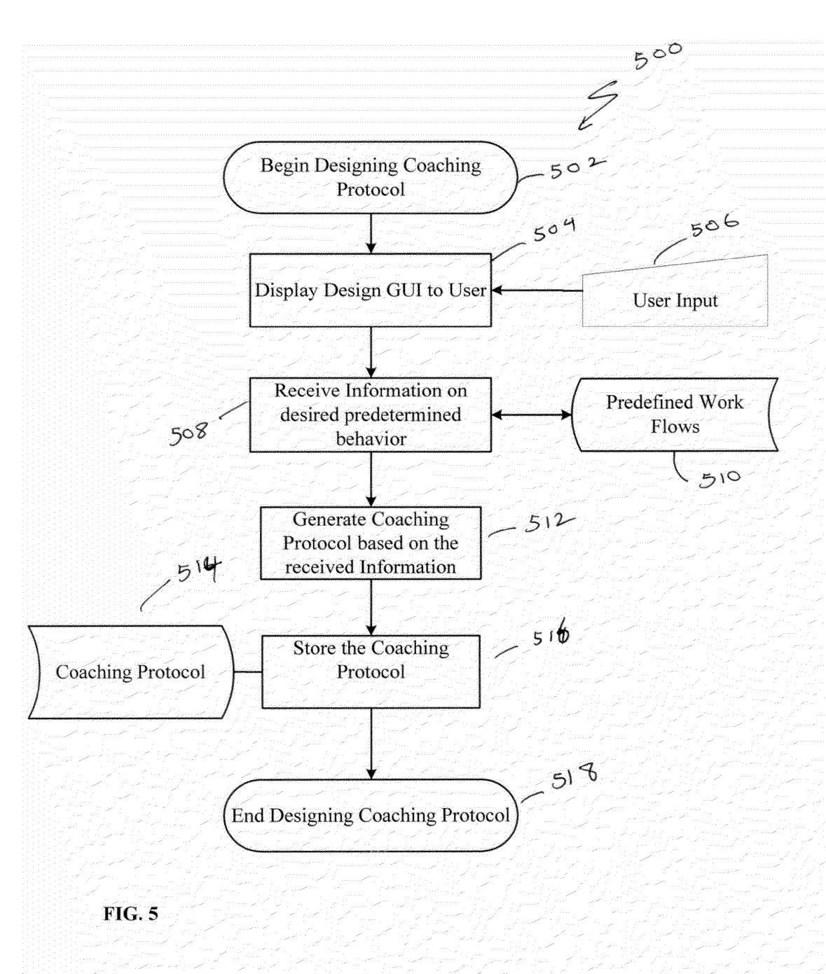

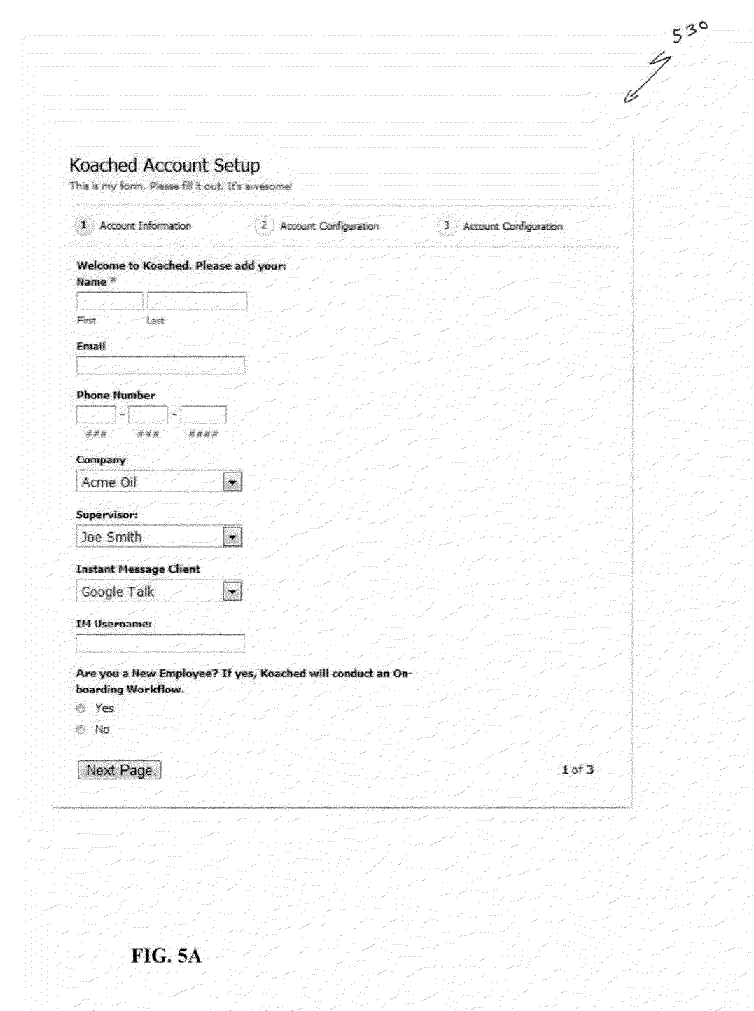

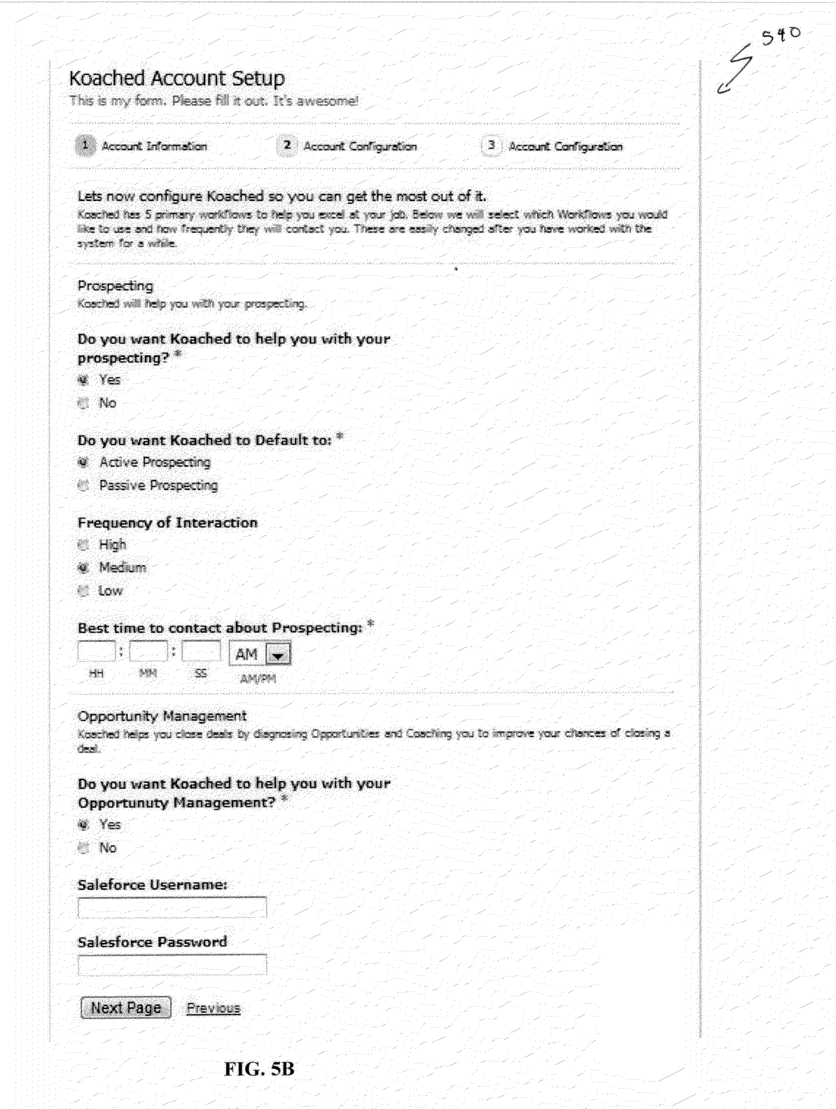

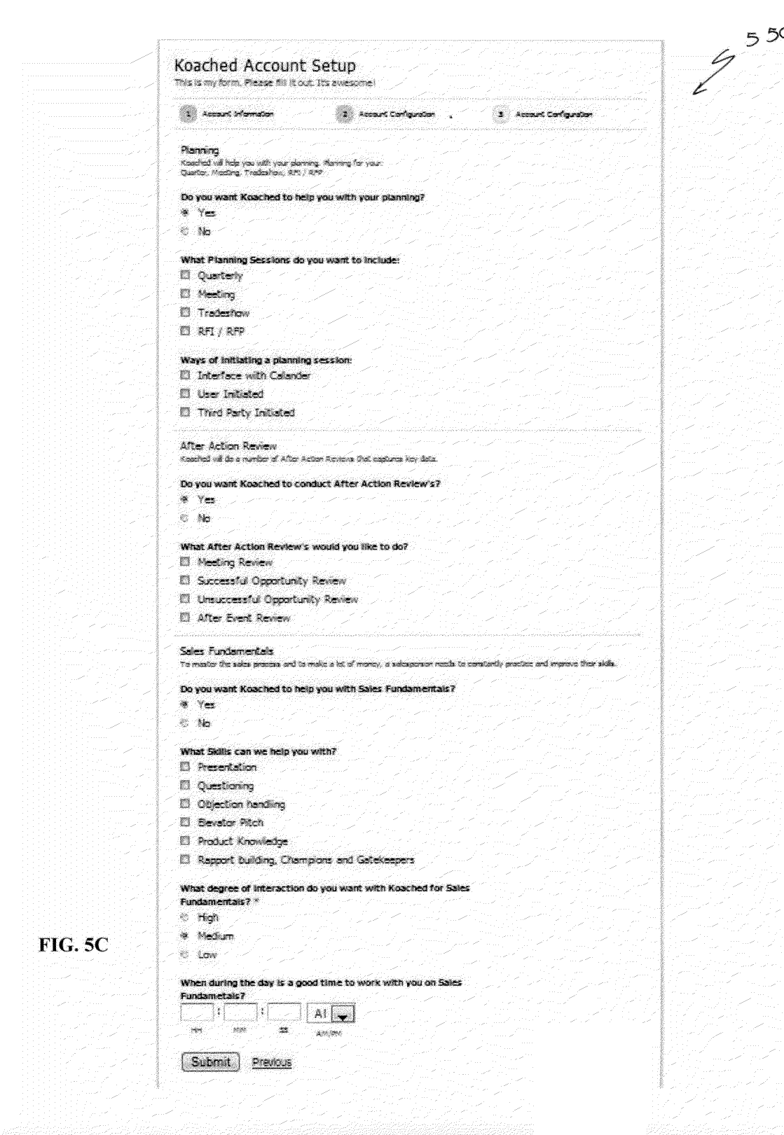

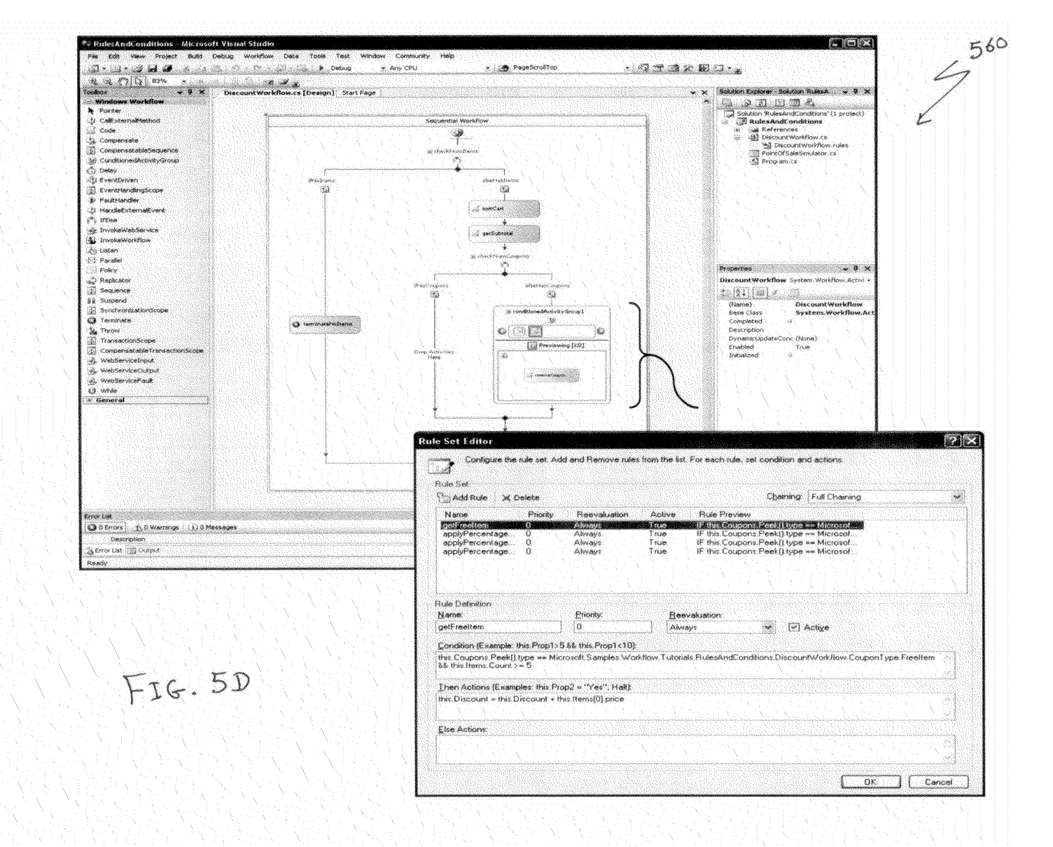

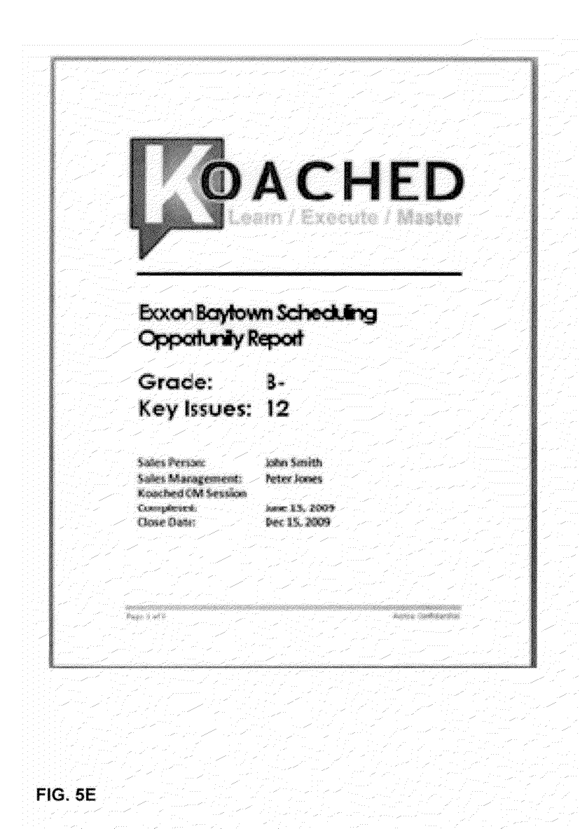

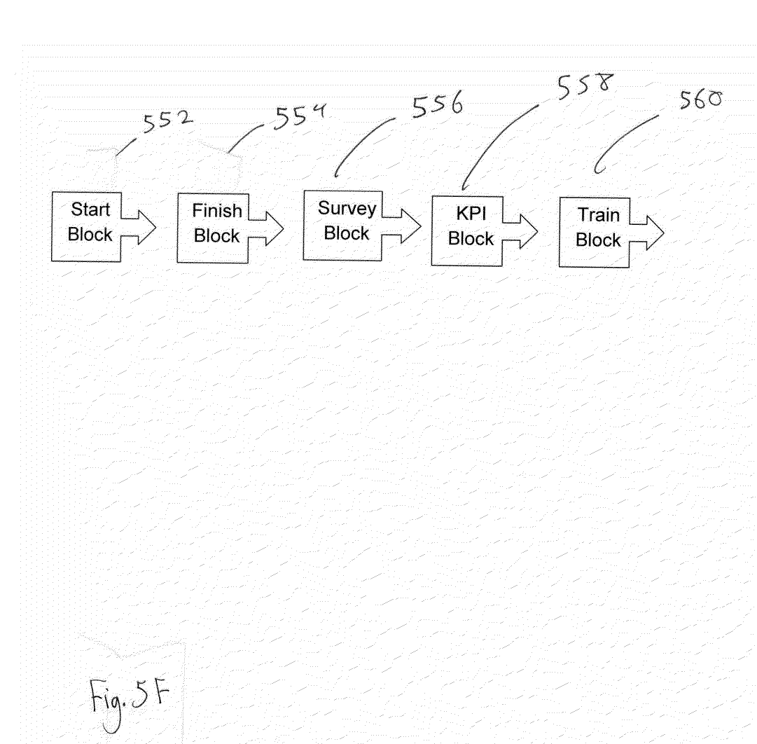

FIG. 4 shows a flowchart of an embodiment of coaching program 208 executed by a coaching computer 108. Coaching program 208 includes a generating step 402 for generating a coaching protocol and storing that coaching protocol, for example, in a permanent storage unit such as permanent storage 204 or permanent storage 310. Coaching program 208 further includes a step 404 for coaching in real-time user 102 in accordance with the stored coaching protocol. Coaching program 208 further includes a step 406 for evaluating data gathered, if any, during step 404. Each one of the steps in coaching program 208 will now be described in reference to FIGS. 5, 5A-F, 6A, 6B, and 7.

FIG. 5 is a flowchart of an embodiment of a computer software program 500 to carry out generating step 402 in FIG. 4. In step 502, a user begins program 500 for designing a coaching protocol. Upon starting program 500, in step 504, a graphical user interface is displayed to the user for designing the coaching program.

In one embodiment, coaching program 208 has a number of predefined and 3^{rd} party generated Guided Sessions that clients can select in their account profile to help them. Coaching program 208 provides platforms to allow clients to develop their own guided sessions or coaching protocols.

In one embodiment, program 208 may provide user 102 or users 118 with “Session Wizard” that walks the client through building their own specific session. It includes asking specific question to configure the session such as what type of session it will be. For example, will it be User Initiated Guided Session, 3^{rd} Party Initiated Guided Session, Active Guided Session, and Less Actively Guided Session. The Session Wizard also employs a workflow wizard that helps build intuitive workflows.

These workflows allow for the representation of the sessions steps but also the logic that defines the interaction. Referring to FIG. 5F, program 208 has, in addition to the standard “Block” Pallet, a “Step” Pallet. These Step Blocks allow for fast creation of effective workflows. Each Step Block has encapsulated into it many steps needed for a specific process. For example, Start Block 552 will define the first few steps of the workflow. Start Block 552 is followed by Finish Block 554, Survey Block 556, Key Performance Indicator (KPI) Block 558, and Train Block 560. Coaching program 208 will also ask questions that configure these steps, as necessary. Guided Sessions generally may have similar sections that have common steps. By allowing clients to select these sections, they can build robust workflows and be guided to configure the rules associated with the sections much easier.

In some embodiments, coaching program 208 includes a Communication API to 3^{rd} party communication applications such as like Tropo™ or Google™ AppEngine that handles all communication to third parties or third party applications. Such programs can send messages including instant messages, automated phone calls, text messages (SMS), automated video messages, emails, or other real-time message for coaching user 102. Coaching program 208 may also communicates with Google Talk™ and Salesforce™ through this API.

The first step is to setup their Client Profile Page at, for example, a website. This profile may be pre-populated by a company or could be setup using a “Job Profile Wizard”. The profile will include standard information about the employee and will use both the employee's Cell phone number and their email address as their Unique Identifier's. The Wizard will also capture their preferred Instant Messaging (IM) client and account name. The Wizard will also capture the Tasks that the employee wants to be part of the Job Task Profile. These tasks can be chosen and then customized from template tasks already populated.

An embodiment of such a graphical user interface is shown in FIGS. 5A-D. FIG. 5A shows an embodiment of a graphical user interface 530 for creating an account for user 102 to be coached by coaching computer 108. The accounts may be created by user 102 or a third-party such as user 102's supervisor or employer. Various information for creating the account is input into graphical user interface 530 including information to be used by coaching computer 108 to communicate with user 102 in real-time such as user 102's e-mail, cell phone number, and instant message client and user name. In addition, other information may also be provided such as the best times for coaching computer 108 to contact user 102 to engage in a guided coaching session, tasks which user 102 needs help with, test parameters that achieve the best results, optimal guided coaching session duration, and other information appropriate the a particular coaching protocol.

After this, user 102 need not use any other tools other than their chosen real-time communication method to engage in a guided coaching session. Coaching computer will use that mode of communication to engage the client and coach him according the chosen coaching protocol.

User 102 or a back-office user 118, such user 102's supervisor, also may use a similar interface to log in to manage the profile, update the information therein, or track the Key Performance Indicators (KPIs) that help track user 102's progress.

FIGS. 5B and 5C show embodiments of graphical user interfaces 540 and 550 for creating a coaching protocol for user 102. Here one of several coaching protocols or workflows may be selected for coaching user 102 and the selected protocol may be customized by selecting from among the various options available for the selected protocol.

Referring back to FIG. 5, user input data 506 which was input using graphical interfaces 530, 540, and 550 are received by coaching computer 108 in step 508. In some embodiments, coaching computer 108 then accesses predefined workflows or coaching protocols 510. In some embodiments, coaching computer 108 may display a graphical user interface such as one shown in FIG. 5D which allows detailed modification of coaching protocols or allow designing from scratch a workflow or coaching protocol for user 102. Such design or modification may be done, for example, by dragging and dropping previously determined behavior steps and connecting those behavior steps to create a coaching protocol or workflow.

In some embodiments, coaching computer 108 presents user 102 or one of the back-office users 118 with a survey or a series of questions with respect to a particular project or task to be performed by user 102. For example, user 102 may provide computer 108 with information with respect to a potential sales opportunity. Computer 108 then presents user 102 with a series of questions or a survey to gather further data regarding the potential sales opportunity.

In some embodiments, based on the data provided by user 102, computer 108 using artificial intelligence technology, such as an expert system, neural network, advanced diagnostics techniques such as, Root Cause analysis (RCA), Failure Analysis, Failure Modes and Effects Analysis (FMEA), Causal model and Fault Tree Analysis (FTA), or other computer technology that would be apparent to a person skilled in the arts, to judge the strength of the potential sales opportunity.

Coaching computer 108 may use an expert system and method to build coaching protocols for various users. Such expert system and method may be derived from methods such as Business Process Modeling (BPM) and Business and Process Workflows. The intent of the system is to interact with people using real-time communications tools such as text messages, instant messages, Twitter™ and automated telephone calls. These “Zero Learning Curve” real-time communication tools facilitate immediate adoption. In short, a user need only have rudimentary knowledge of modern communication in order to be able to interact with coaching computer 108.

Coaching program 208 may use a platform to automate the real-time, interactive coaching of users according to various coaching protocols. For example, coaching program 208 may allow users to develop unique behavior change routines on whatever topic desired, with the goal of changing or adopting a particular behavior. Coaching program 208 may present user 102 or one of users 118 with a coaching profile wizard that will walk the user through identifying a behavior that they want to develop or change. The wizard will then query the user with the goal of having the client breakup the master behavior into smaller actionable steps. The wizard then applies techniques such as mental contrasting to help ensure the behavior goal is met. Mental contrasting is a technique that involves imagining the benefits of achieving a goal first, then thinking of obstacles in the way of achieving that goal. From this, a more effective behavior modification coaching protocol may be developed. The wizard will gather data from user 102 or user 118 on what abilities user 102 will need to develop for achieving their goal. This may include curriculum around the behavior. An example of curriculum might be chapters from a book or custom curriculum suggested by coaching program 208 or other third parties for particular behaviors such as steps for quitting smoking or steps for managing large sales account. The wizard may gather data about what user 102's motivations are for having the behavior. The wizard may then develop a timeline and schedule for how the coaching protocol may last and what goals and targets are to be met over the timeline. The wizard will also develop a library of messages to be sent to the client as triggers to take certain step of the behavior change program, messages of encouragement or admonishment, and messages for gathering data on how well the user is doing with the program.

For example, based on the information provided, various factors relating to a sales opportunity may be assigned a weighted value and based on the totality of those factors, computer 108 may assign a grade to that sales opportunity and identify key issues regarding the potential sales opportunity and provide a report such as one shown in FIG. 5E. In some embodiments, coaching computer 108 may generate a coaching protocol to guide or coach user 102 to take steps to improve the grade assigned to a sales opportunity. Once the coaching protocol or workflow is generated, computer 108 then proceeds to coach user 102 to achieve the defined goals. Computer 108 may perform frequent surveys of user 102 to measure compliance with the workflow and may escalate noncompliance to upper management.

In another embodiment, computer 108 asks a number of questions from user 102 or one of the back-office users 118 about goals for user 102 for a predetermined period, such as a quarter or three months. Based on the answers, computer 108 generates a coaching program or workflow of steps to be performed by user 102 by certain dates to meet those goals. Computer 108 may, for example, generate a report at the same time as generating a coaching protocol. In addition, computer 108 may use artificial intelligence technology to determine what steps to take towards completing certain goal should be taken so that for example steps toward goals that may require a longer investment of time or may rank higher in priority should be taken earlier than steps toward other goals. In some embodiments, a back-office user 118 who may be a member of the management may be presented with a modifiable workflow and that user may modify the workflow to meet the goals of the business. Once the coaching protocol or workflow is generated, computer 108 then proceeds to coach user 102 to achieve the defined goals. Computer 108 may perform frequent surveys of user 102 to measure compliance with the workflow and may escalate noncompliance to upper management, to a new process for modifying the coaching protocol, or to another third party.

The key to coaching in accordance to an embodiment of the methodology set forth herein is focused hard work for short periods, a systematic method for pushing your learning boundaries, breaking tasks into small, quickly, and/or easily accomplishable behavior components or steps, and being coached to systematically engage in those behavior components or steps. In addition, having immediate and actionable feedback and coaching can further assist to improve performance.

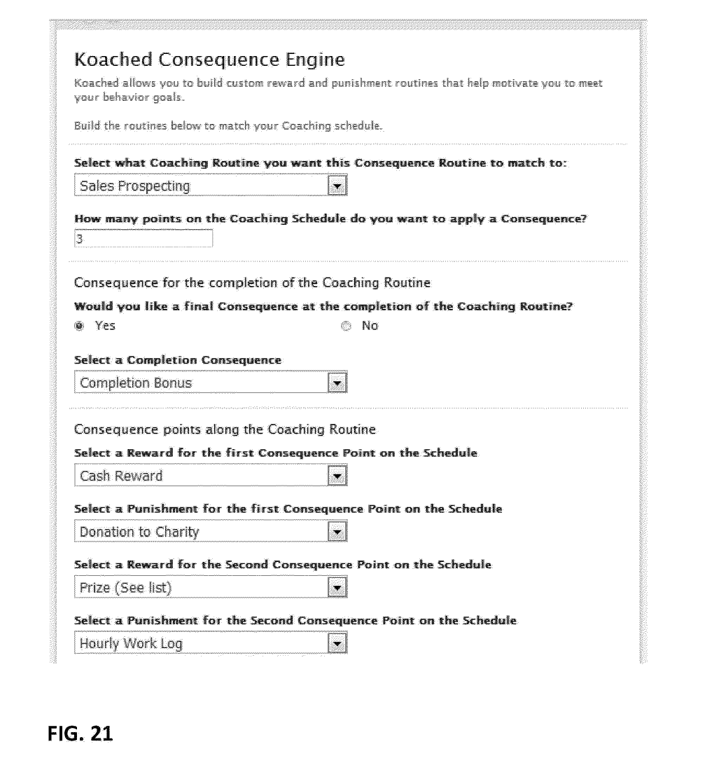

In addition, in some embodiments, coaching program 208 may include a consequence engine. FIG. 21 shows an example of a graphical user interface for interacting and inputting data into such a consequence engine. The engine may have several components. It may include a consequence wizard for outlining rewards and punishments to be applied to custom behavior programs (that is, coaching protocols). These rewards and punishments may be tied to the behavior change timeline, discussed above. As goals are met, the user will be rewarded. If goal is missed, the user will be punished. Such rewards and punishment may be a cash deposit/donation tool whereby the user or a third party such as his employer will deposits an amount of money that will be controlled by coaching program 208. As goals are met, coaching program 208 releases a predetermined amount of the money to the user. As goals are missed, the money is donated to a charity of the user's choosing or returned to third party.

Alternatively, rewards and punishments may be of nonmonetary types. For example, a list may be provided that outlines the kinds of rewards the user will get or the kinds of punishment they will receive. Rewards could be the purchase of items chosen by the user and put on a reward wish list. Punishment can be emails is sent to several of the user's close contacts telling them of the missed goal, notifying his supervisors, a status post on a social network site such Facebook™ stating that the user did not meet their goal, or personal one such as “no TV for a week” and alike.

Rewards and punishments can have both periodic and target levels. If the user is meeting their goals at certain stages, they will be rewarded. If they meet a target (for example, typing at 100 words a minute) they will get a reward. At the end of the timeline the client (that is, the user) can also either rewarded or punished depending on success of meeting their overall behavior goals.

The consequence engine may have the ability to grade progress based on some criteria. For example, it may assign grade such as A+, B−, C+ etc. based on weighted metrics.

After coaching protocol 514 is generated, coaching program 208 may include the ability for a third party, e.g., the user's supervisor or users 118 or coaching consultant provided by a coaching service provider, to ensure the quality of coaching protocol 514 and allow modification.

Referring back to FIG. 5, after coaching computer 108 in step 508 generates a coaching protocol 514 based on user input data 506 and predefined workflows 510 if any, coaching computer 108 in step 516 stores coaching protocol 514 in a computer accessible memory or storage. Coaching protocol 514 includes a plurality of behavior steps which when performed by user 102 results in user 102 performing the desired behavior or achieving the desired outcome. Coaching computer 108 then terminates program 500 in step 518.

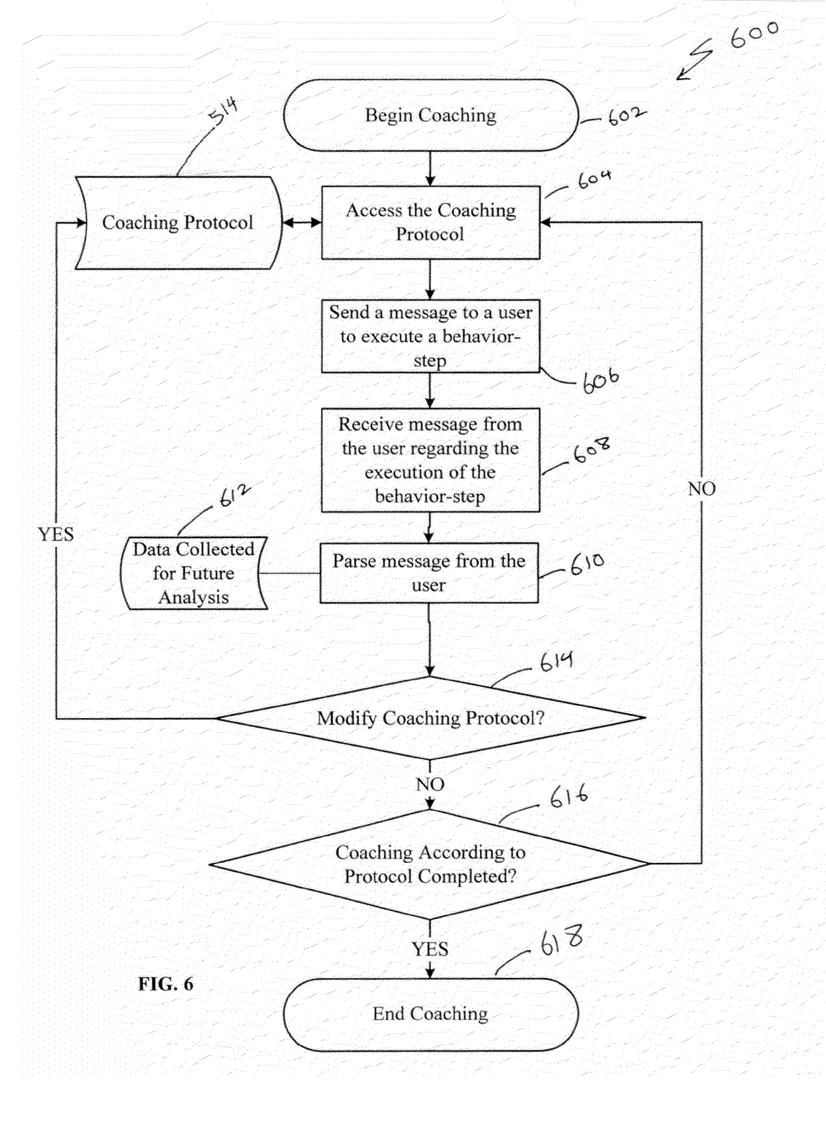

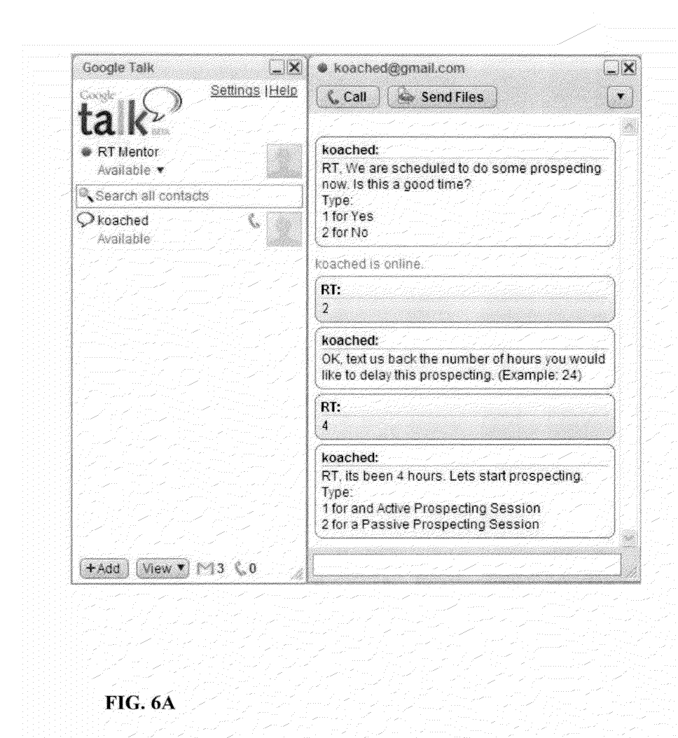

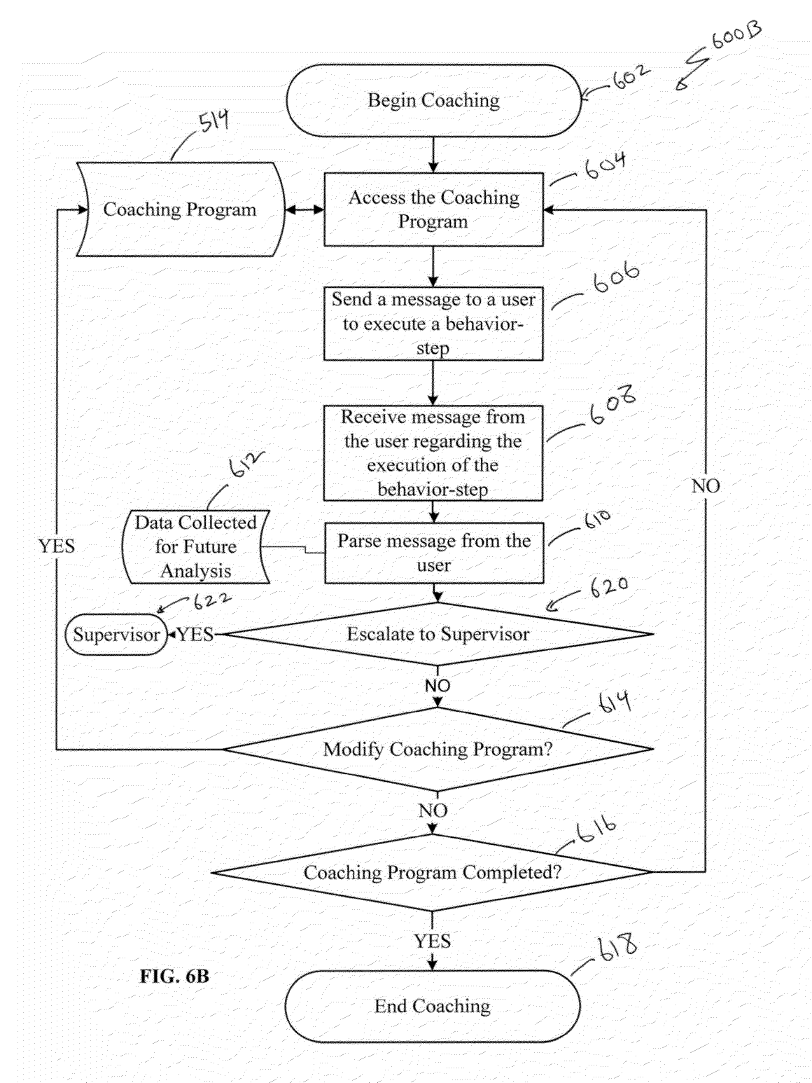

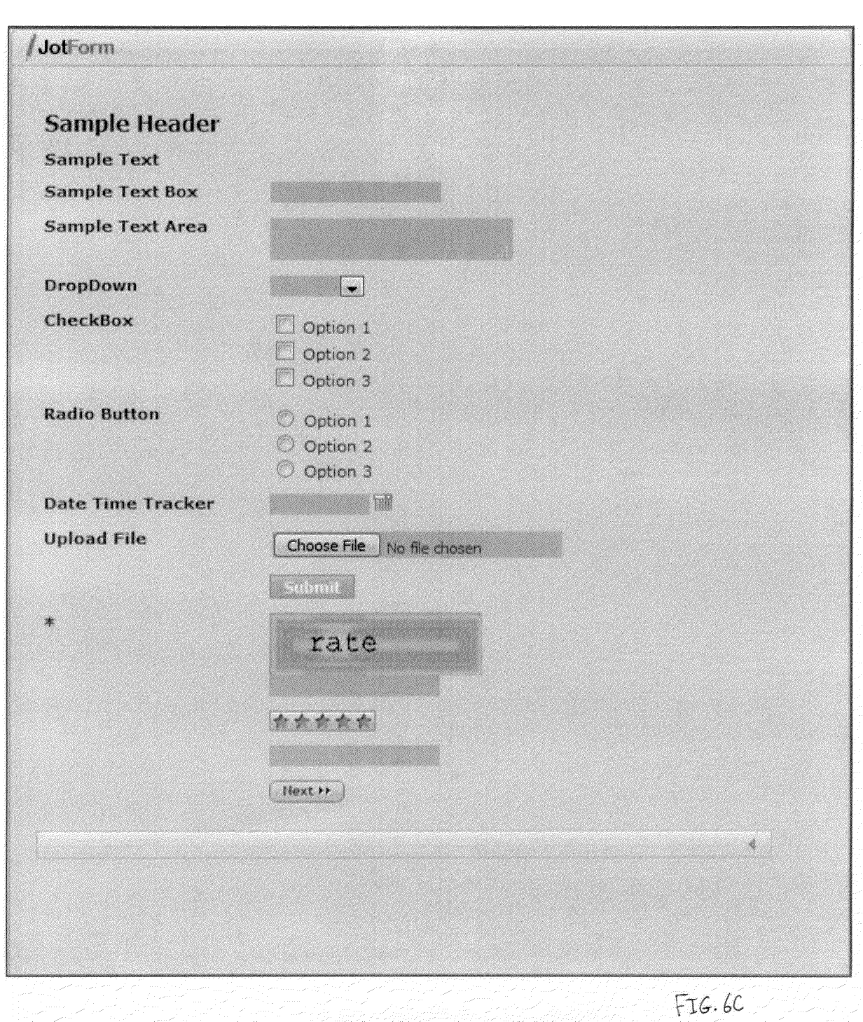

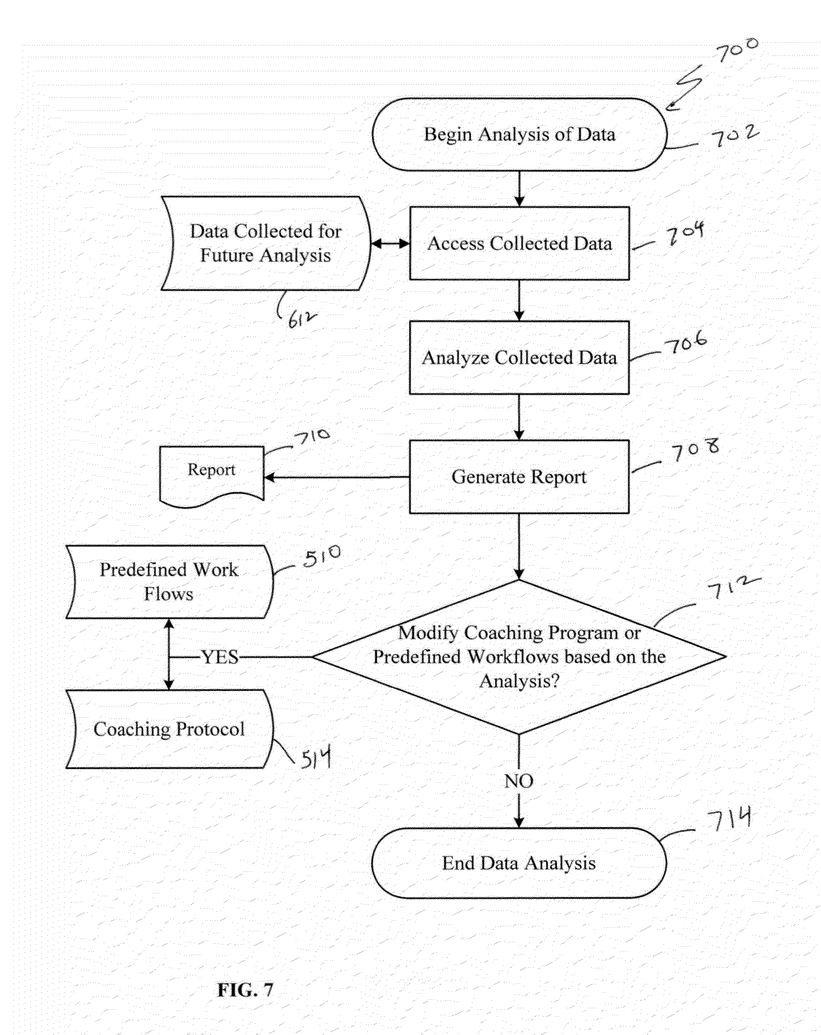

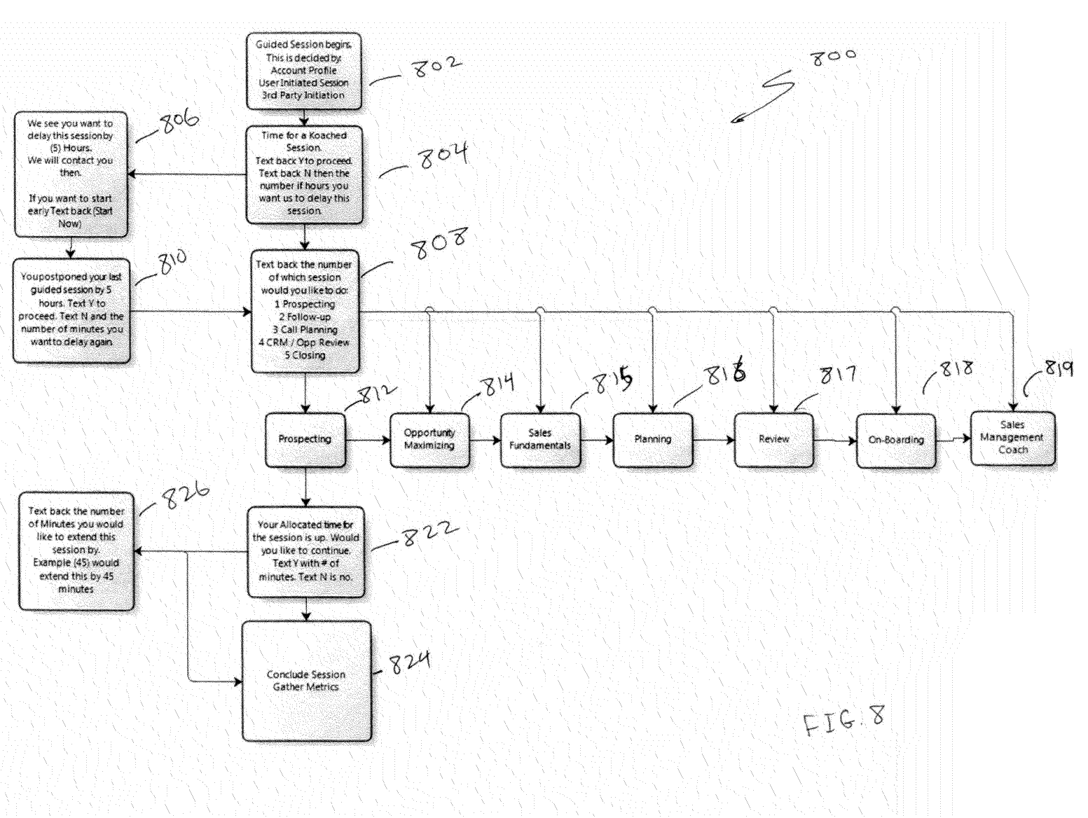

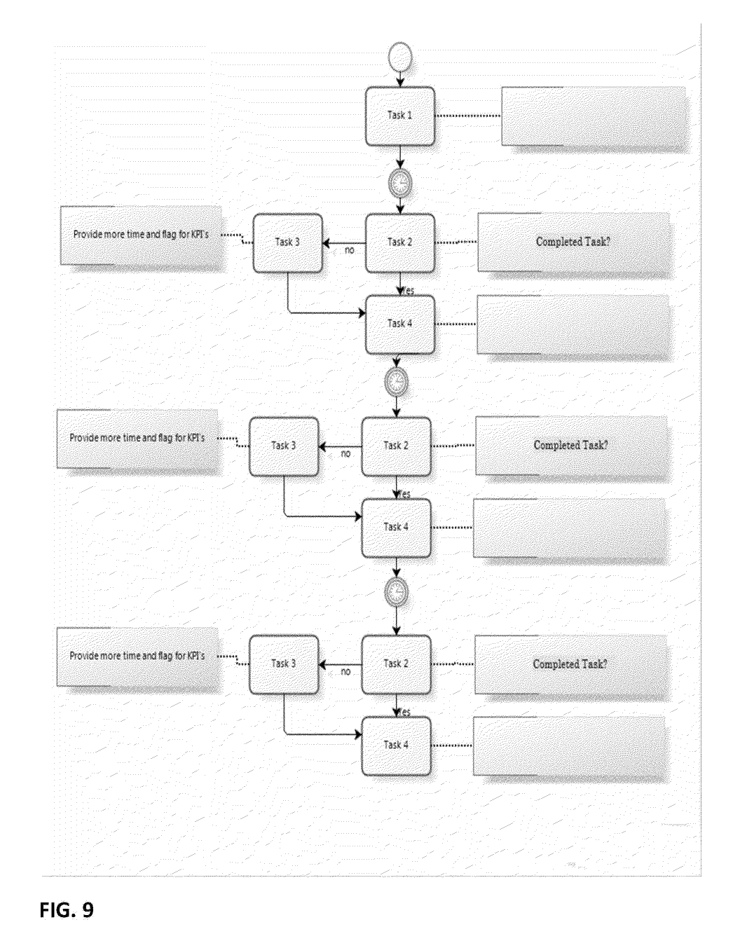

FIG. 6 is a flow chart of an embodiment of a computer program 600 that implements the step 404 of FIG. 4 for coaching user 102 according to coaching protocol 514. After computer program 600 is started in step 602, coaching computer 108 in step 604 accesses coaching protocol 514 stored in step 516 of FIG. 5. In accordance with coaching protocol 514, coaching computer 108 in step 606 sends a message in real-time to user 102 to execute the first of the behavior steps in coaching protocol 514. The real-time message may be a Short Message Service (SMS), an Enhanced Message Service (EMS) text message, an automated phone call, or any other type of real-time communication message sent to user 102's cellular phone 110, smart phone 112, PDA 114, computer 116 (all shown in FIG. 1), or any other device capable of receiving such a real-time message. The real-time message may also be an instant message (IM) as shown in FIG. 6A or an e-mail message that is received in real-time by user 102. In other words, the real-time message may be any kind of an electronic message capable of being sent by a computer to another computer or device in real-time.

Alternatively, a thin client program can run on user 102's cellular phone 110, smart phone 112, PDA 114, laptop computer 116, or other computer or device to enable a more complex real-time communication and coaching. For example, such a thin client can run on a smart phones such as those sold under the brands IPhone™, BlackBerry™, Windows OS™, or Android™ or Nexus™ by Google Inc. or computers such as net books or IPad™. FIG. 6C shows an example of a graphical user interface used by a thin client on such a device to coach user 102.

In step 608, coaching computer 108 receives a message from user 102 regarding the execution of the behavior step by user 102. Upon receiving such a message, coaching computer 108 in step 610 parses the message from the user to obtain data regarding the execution of the behavior step by user 102 and stores such data 612 for future analysis. In some embodiments, the parsing may be done by the thin client running on the user's device. Such a thin client may guide the user to enter information in such a way that it is parsed and the relevant information is sent in a real-time message such a text message to coaching computer 108. In some embodiments, coaching computer 108 gathers data not only from user 102 but also from other sources such as the news, other users 104 being coached, user 102's supervisor, users 118, human coaches, other computer programs such as SalesForce™, or any other data point that may be useful in determining the best way to coach user 102.

Coaching computer 108 then determines in step 614 based on the gathered data (e.g., from the message received from the user and/or data from other source) whether coaching protocol 514 should be modified or not. If coaching protocol 514 should be modified, coaching computer 108 modifies coaching protocol 514. If coaching protocol 514 need not be modified, in step 616 coaching computer 108 determines whether to continue coaching user 102 or to end coaching user 102. If it is determined that the coaching should continue, coaching computer 108 loops back to step 604. If it is determined that the coaching should be terminated, coaching computer 108 ends coaching in step 618.

FIG. 6B is flowchart of an alternative embodiment of a program 600B that implements step 404 shown in FIG. 4. Program 600B is similar to program 600 shown in FIG. 6A except for an additional step 620 wherein program 600B determines, based on the message received from user 102 in step 610, whether the performance of user 102 should be brought to the attention of a supervisor 622 or another third party. The supervisor or the third party may then review user 102's performance and, for example, determine whether the coaching protocol need to be modified or whether user 102 requires further assistance. Alternatively, various consequences may be administered in step 620 based on user 102's performance. For example, the user may be rewarded or punished according to consequences that have been predefined in the coaching protocol (as discussed in reference to FIG. 21).

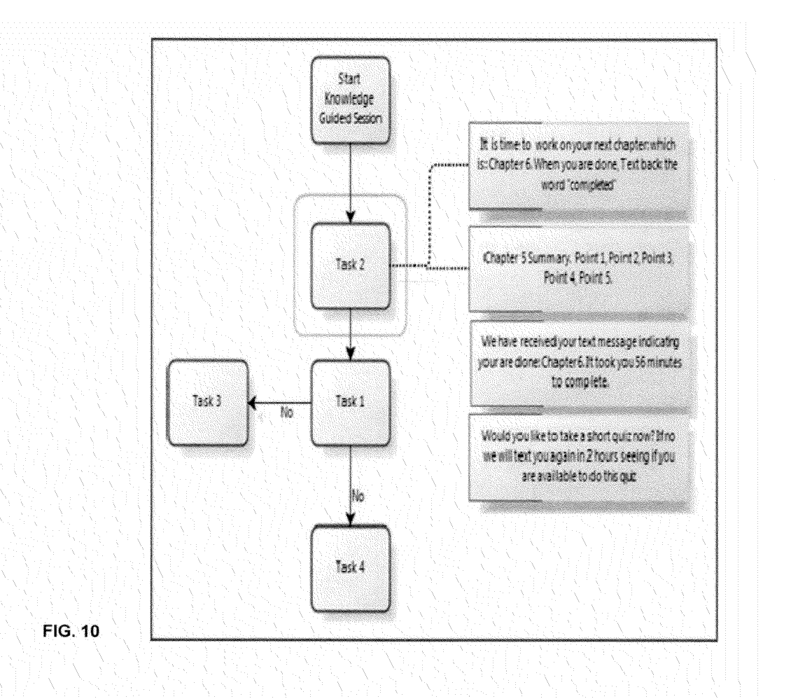

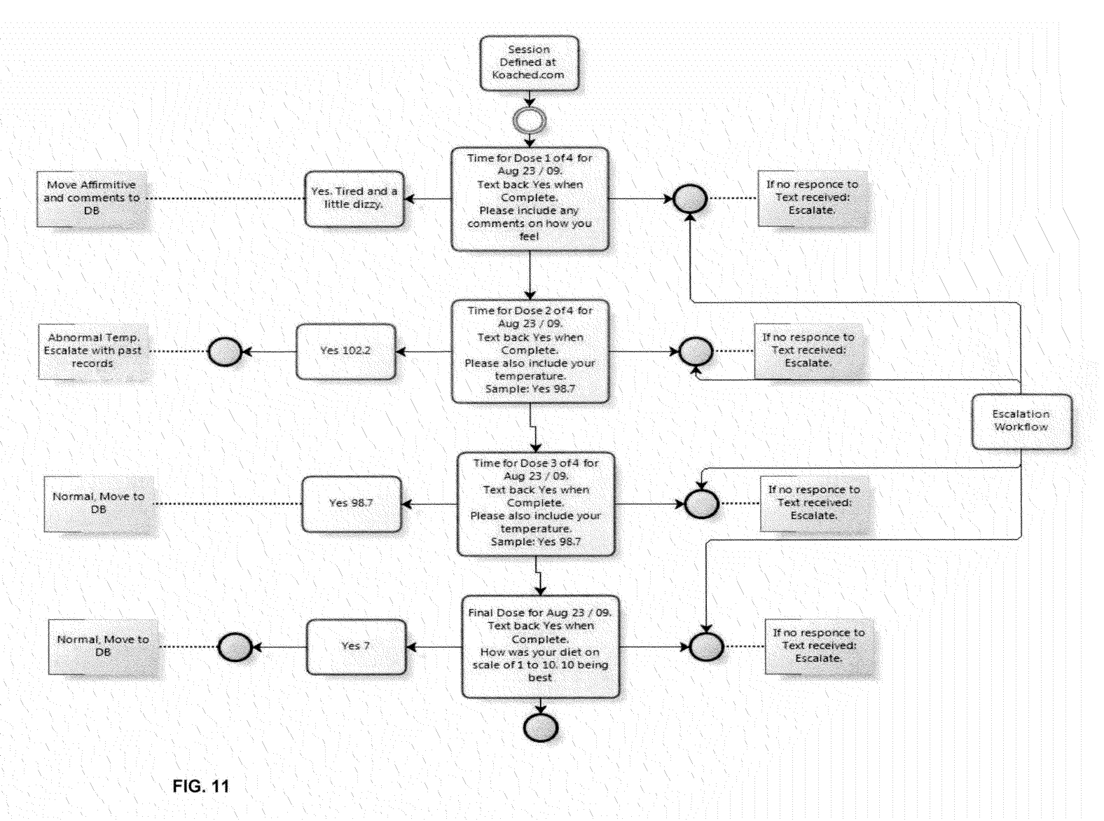

FIG. 7 is a flowchart of an embodiment of a program 700 executed by coaching computer 108 to implement analyzing step 406 shown in FIG. 4. Upon program 700 being started in step 702, coaching computer 108 in step 704 accesses data 612 collected previously. In step 706 coaching computer 108 analyzes collected data 612 based on various predetermined criteria, such as the success of user 102 in executing the various behavior steps in coaching protocol 514, the speed at which user 102 executed those steps, feedback by user 102 on the efficacy of those steps for achieving the desired end results, and any other factors that may be pertinent in a given case. Based on the analysis in step 706, coaching computer 108 in step 708 generates a report 710. Based on the analysis in step 706, coaching computer 108 then determines whether to modify coaching protocol 514 and/or predefined workflows 510 and accordingly modifies one or both, if necessary. Coaching computer 108 terminates program 700 in step 714.

The computer-implemented automated coaching methodology using real time communication described above can be used for various purposes. For example, it can be used for real time coaching of students to study for a subject or a test, athletes to train for specific sports, sales people to engage in sales activities, patients to learn and comply with complex drug regiments, healthcare workers to learn and perform complex new health care tasks and procedures, and so on. Examples of coaching protocols for such applications will now be described.

FIG. 8 is an example of a sales force coaching protocol or workflow 800 used by coaching computer 108 for coaching user 102. After a coaching session is started in step 802, coaching protocol 800 requires sending a message 804 to user 102. Message 804 requires a response from user 102 and based on the response from user 102, coaching protocol 800 requires sending either a message 806 or a message 808. Message 806 is sent in case user 102 wants to delay the coaching session. Depending on the period of time user 102 wants to delay the coaching session, coaching protocol 800 requires sending another message 810 after the expiration of that period.

Coaching protocol 800 requires sending a message 808 when user 102 wants to begin a coaching session. User 102 is given a choice of one of a number of different sales behavior steps to choose from. Those sales behavior-steps, which can be thought of as coaching sub-protocols, are prospecting 812, opportunity maximizing 814, sales fundamentals and training 815, planning 816, opportunity review 817, on-boarding 818, and customer relations management (CRM) and sales management coaching 819. Each one of these behavior steps may include more detailed behavior sub-steps to assist user 102. For example, coaching protocol 800 may require sending a message directing user 102 to watch a training video, to listen to an audio recording, or to attend a webinar. In addition, coaching protocol 800 may require sending messages which would make inquiries of user 102 with respect to prospective sales opportunity and based on the answers to those questions, coaching computer 108 may evaluate the sales opportunity and may modify coaching protocol 800 to better assist user 102 in pursuing a sale. Furthermore, coaching protocol 800 may require that before proceeding to the next behavior step that user 102 be in compliance with a predetermined standard, such as completing a predetermined number of cold calls. In some embodiments, coaching protocol 800 may incorporate timelines which ensure user 102 meets a predetermined timeline.

Coaching protocol 800 requires sending a message 822 after pre-allocated time period has expired. If user 102 sends a message back that he or she requires more time, coaching protocol 800 requires sending a message 824 allowing the extension of the pre-allocated time for performing the selected behavior step. Finally, coaching protocol 800 requires concluding the coaching session. Other examples of coaching protocols are shown in the attached appendices.

Another example of would be a coaching protocol for a Pharmaceutical Representative (PR). A PR's core responsibility is to increase the sales of a company's products. The PR does this by engaging in many different tasks:

1. Creating and executing a sales plan

2. Product Knowledge

3. Client Management

4. Presentation Skills

5. Pre-call Planning

6. Post-call Audit

7. Merchandising Product

8. Prospecting new clients

9. Conferences

10. Collaborating with coworkers

11. Developing core sales skills

An example of a coaching protocol for a PR may include 5 primary tasks (though there may be more):

1. Product Knowledge

2. Pre-call Planning

3. Prospecting

4. Administrative

5. Client Management

As an example, let us consider the Product Knowledge Task. All PR's need to have a deep knowledge of the products they sell and the key benefits for their customers. With the ever changing product mix and a highly mobile workforce, achieving this high knowledge level can be hard for pharmaceutical companies to achieve. Therefore a coaching protocol can engage PR's into highly productive “Guided Work Phases” which both break the task into mini-goals and positively test with feedback to improve performance.

Product knowledge task can be implemented by a coaching protocol that is a Less Actively Guided Protocol, a More Actively Guided, or a Situational Guided Protocol, as described already.

The primary goal of the coaching protocol for the Product Knowledge task is to actively engage the client in a focused period of time to work on their product knowledge. Depending on how the Client Profile is setup, the coaching protocol may dictate that coaching computer 108 to engage the client to focus on a certain chapter in their Product Sales Kit, or it may be something less defined that the client chooses to engage in on their own. Flow charts of examples of such coaching protocols are shown in FIGS. 9 and 10.

Another example of a coaching protocol is one for coaching students to study for the SAT's or other academic pursuits. Engaging a student in short focused study sessions, in conjunction with frequent tests and immediate feedback at the start of a school year could have dramatic effect on the student's performance on their future tests. It also is an excellent way of identifying areas the student may need to focus on for maximum benefit, while doing so in a fairly unobtrusive way.

Another example of a coaching protocol is the health management area. FIG. 11 shows a flow chart of an example of a coaching protocol for managing people to take the drugs they need when they need it, escalate emergency issues, and track key health data.

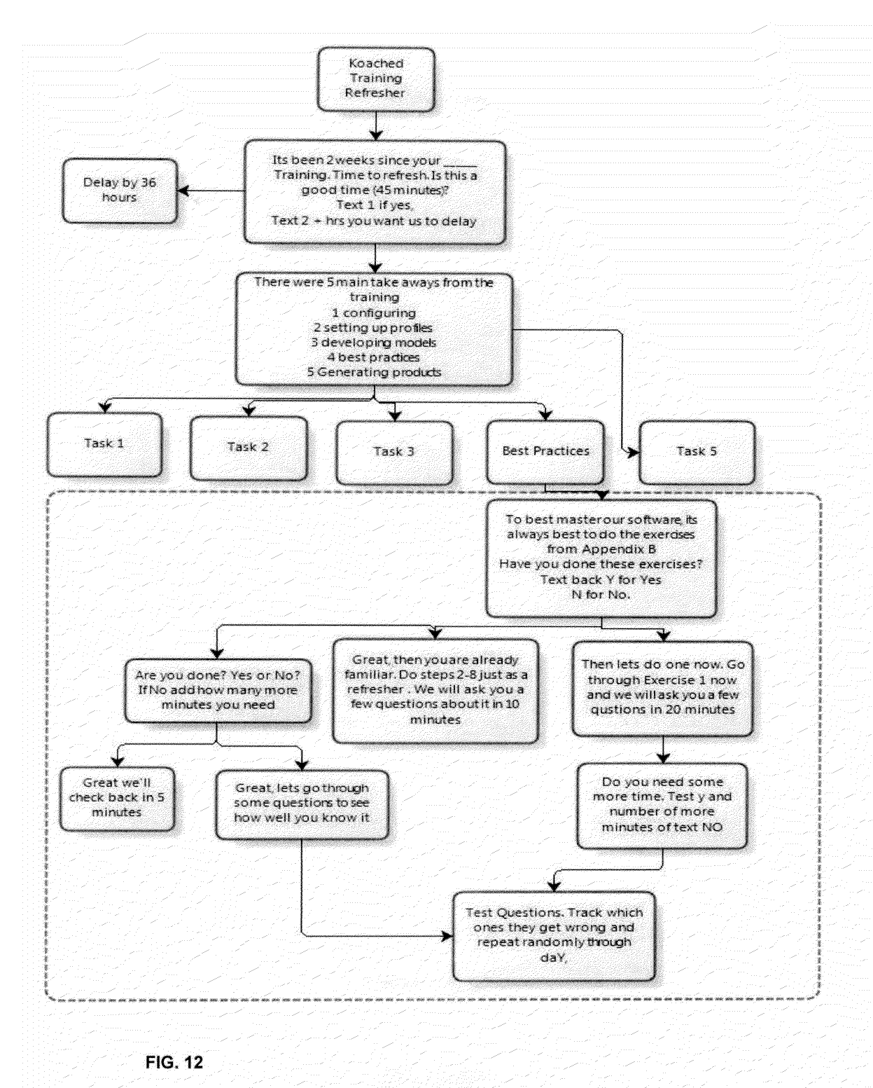

Yet another example coaching protocols in the area of company training. Companies spend billions of dollars every year providing training to their employees. The training is rarely adopted by the students as intended. Referring to FIG. 12, coaching system 108 can provide a tool that makes this training “stick” by reinforcing the training after the class is complete. Behaviors are learned over time and by practice.

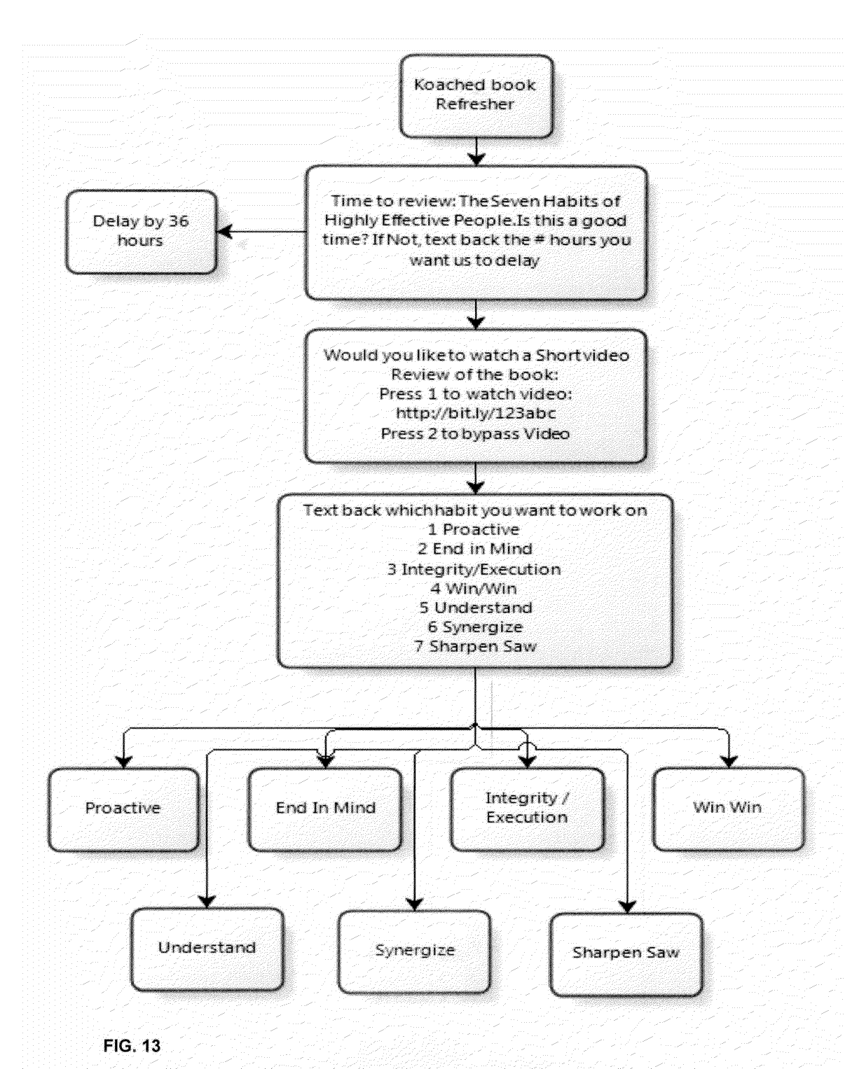

Another example is coaching protocols to assist persons using self-help or training books or engaging in bibliotherapy. Self help books and their recommendations can be used to create workflows or coaching protocols to assist readers of such books to practice and master the teachings of those books. FIG. 13 shows an example of such a coaching protocol.

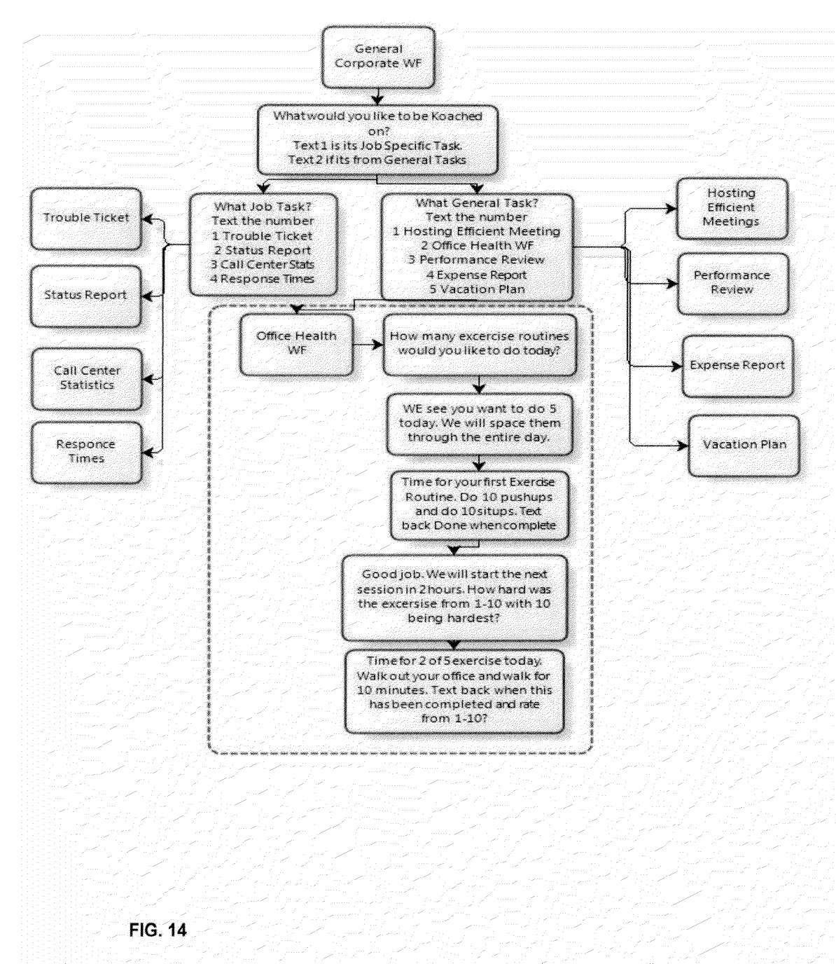

Another example of a coaching protocol is one the in the area of human resources performance. Most companies describe their employees as being their most valuable asset, but most have little infrastructure to help these employees continually improve. Even without this infrastructure, employees are normally a company's only “Appreciating Asset”. Coaching computer system 108 can be the infrastructure that helps companies invest in their employees. An exemplary coaching protocol is shown in FIG. 14.

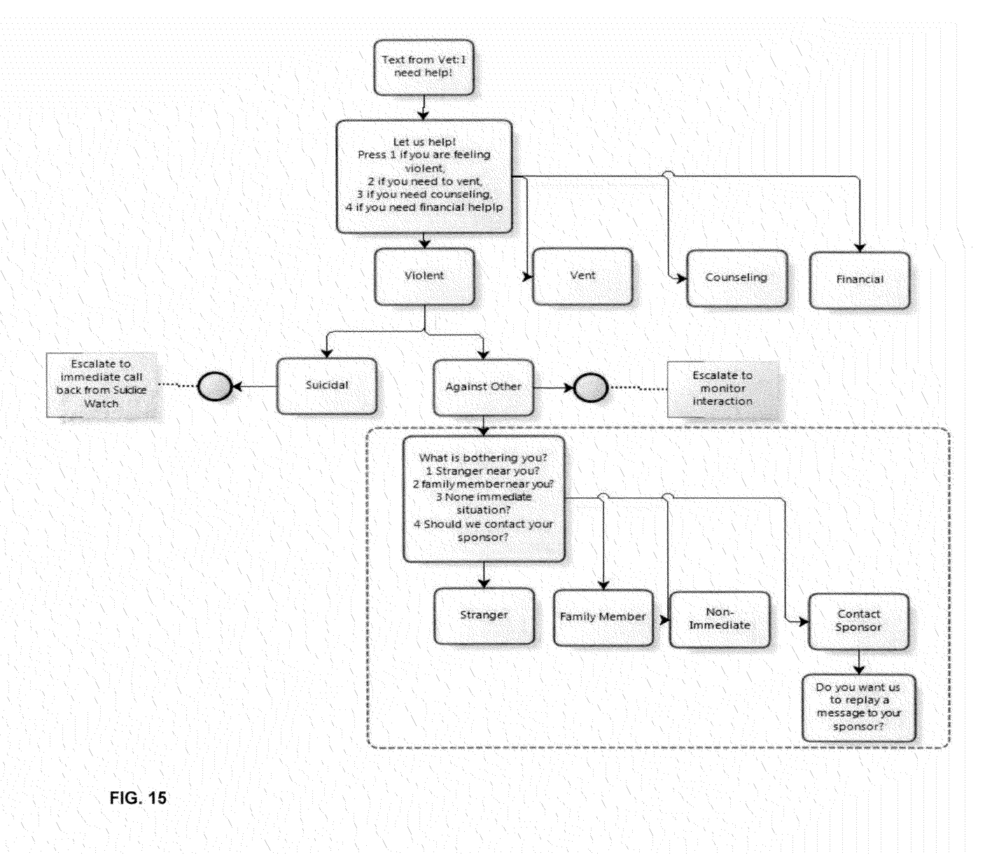

In yet another example, coaching protocols can be used for counseling and support. For example, the United States' Veterans Administration (VA) has trouble providing assistance to those veterans who need help but do not like working with the VA. Referring to FIG. 15, coaching computer system 108 could provide a system to provide real-time guidance to veterans in a non-threatening way, while also providing a method to escalating real-time issues that can potentially be harmful.

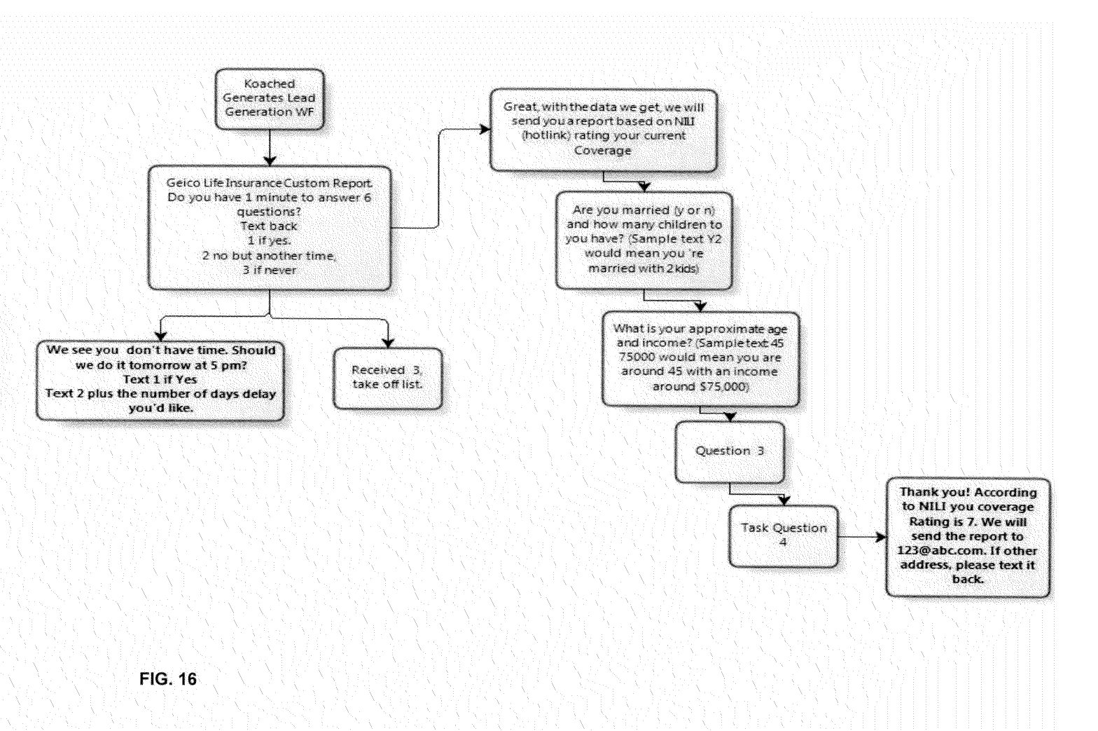

Another example of is using coaching protocols in the area of lead generation and customer service. Referring to FIG. 16, coaching computer system 108 could provide companies a way of communicating with their clients that gathers important information and customizes the service or quote delivery.

In yet another embodiment, computer 108 assists user 102 to comply with various legal and regulatory regimes that govern the business for which user 102 works. In this instance, computer 108 may generate workflows which present user 102 with compliance checklists which user 102 then completes. Because of the complexity of legal and regulatory regimes, a compliance workflow may include steps and checklists for multiple users 104 to be performed sequentially or concurrently. Computer 108 may actively pursue the involvement of various users as they are needed and escalate issues as certain steps are not completed in timely fashion or not completed at all.

In another embodiment, coaching program 208 asks a series of questions in a survey relating to a sales opportunity. From these answers, coaching program 208 then grades an opportunity based on specific metrics. Based on the answers and the assigned, computer program 208 then automatically develops an action plan embodied in a coaching protocol to assist user 102 to best take advantage of the sales opportunity. The coaching protocol may include goals such as getting more information, providing more information, doing series of steps to meet objective, and correcting identified red flags.

For example, referring back to FIG. 5E, the sales opportunity “Acme Computer needs 50 laptops” is entered into Salesforce. Coaching program 208 identifies the opportunity and proactively initiates a survey with the account manager to qualify this opportunity. A number of questions are asked to gathering data for judging the opportunity. The answers are weighed and this sales opportunity gets the grade of B−. Coaching program 208 then creates an action plan embodied in a coaching protocol that pushes the account manager to get more information on the potential buyers and the competition and correct any red flags, e.g., “Accounts Payable freeze on account because of outstanding invoice.”

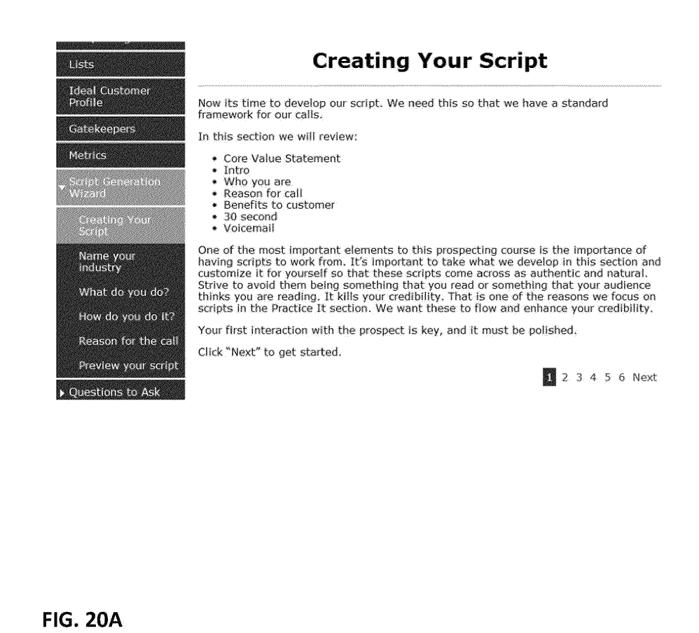

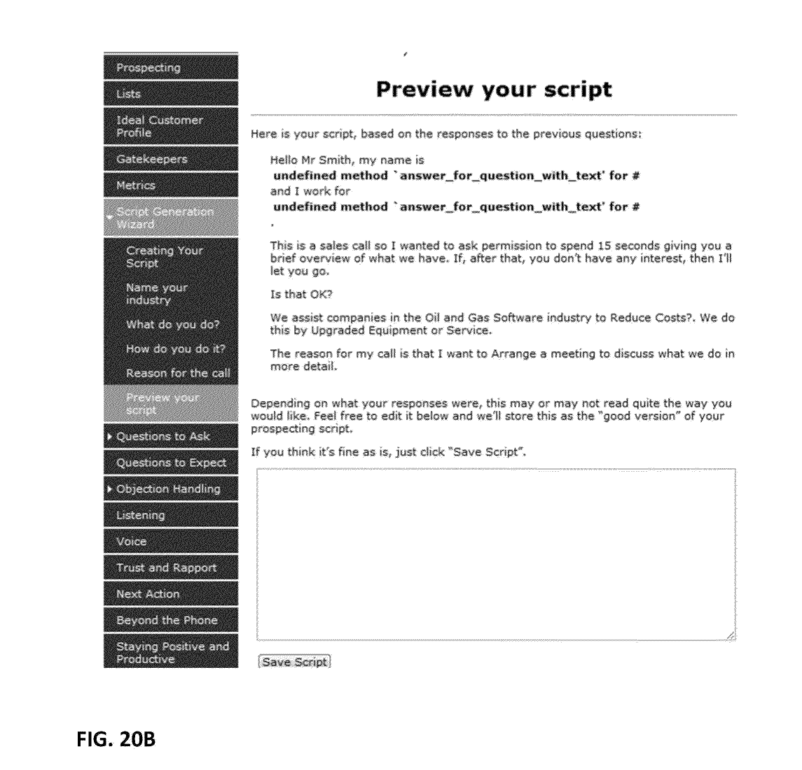

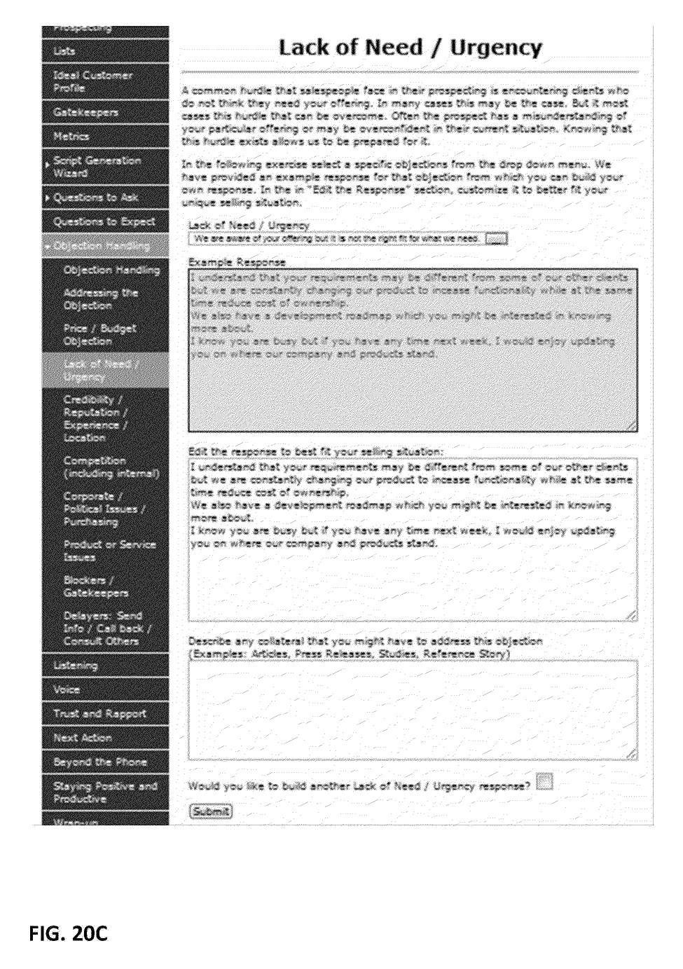

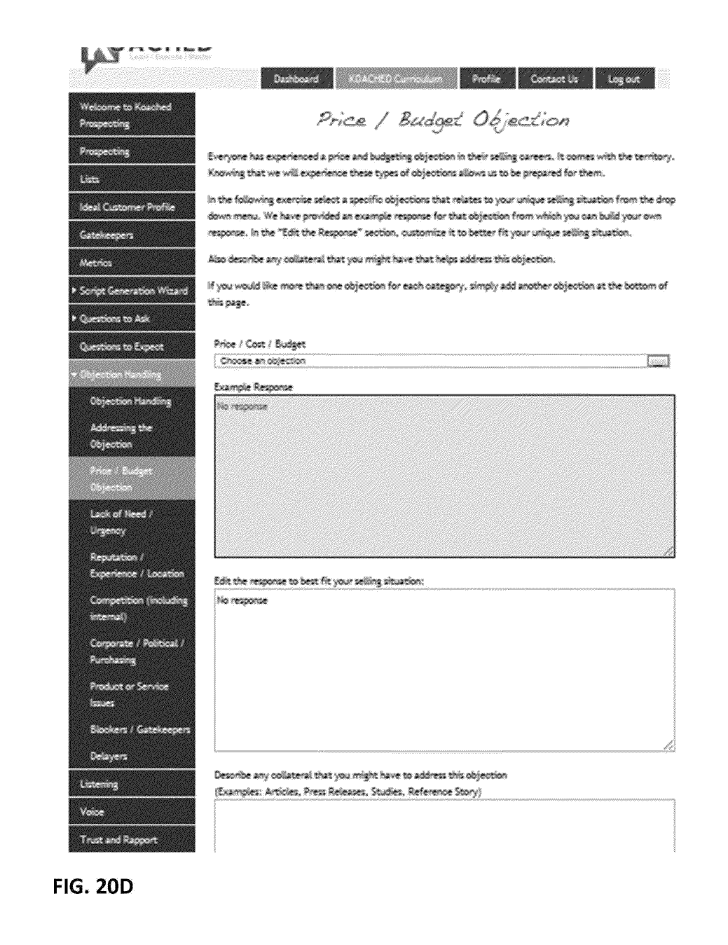

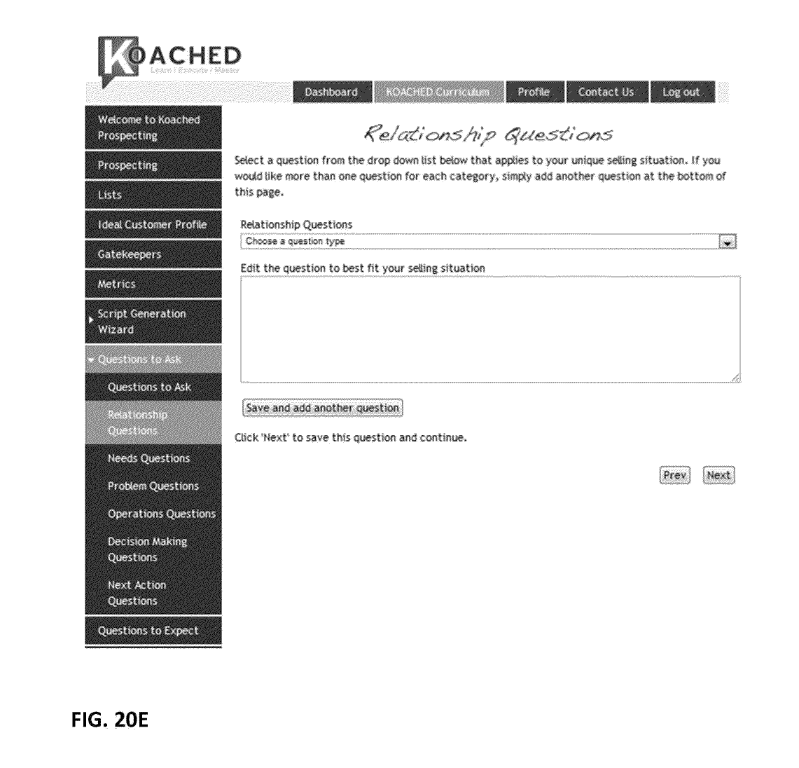

In addition, coaching program 208 may utilize a script generation engine. FIGS. 20A-E show examples of graphical user interfaces of a script generation engine presented to the user by coaching program 208. Upon being started (FIG. 20A), such a script engine may user artificial intelligence to suggest a series of scripts for approaching a potential customer, which the user may modify (FIG. 20B). The script engine may identify potential questions, objections or obstacles typically faced by a salesperson selling a particular product and provide suggested scripts for dealing with those objections and obstacles, such scripts being modifiable by the user (FIGS. 20C and 20D). The script engine may also suggest, or prompt the user to enter, scripts for building relationships with potential customer (FIG. 20E). These scripts may be stored and selected from a library kept by the business and updated as different salespersons suggest or modify the scripts already stored therein. In some embodiments, there may be separate software components for generating first approach scripts, questions and objections handling scripts, and so on.

In an embodiment, coaching program 208 assists in developing a quarterly plan and a coaching protocol to coach user 102 to achieve that quarterly plan. Coaching program 208 questions user 102 on what user 102's goals are for the next 3 months. Coaching program 208 uses a survey, a wizard, or a script that asks questions about activities for the quarter. Coaching program 208 then generates a report that outlines the goals and in a coaching protocol breaks out what needs to be done by certain dates to meet the user's goals. Coaching program 208 may then allow modification of the goals and/or the coaching protocol provide user 102, users 108 (e.g., user's supervisors or managers), or coaching consultant such as a person in employment of a business that provides coaching computer 108 and coaching program 208 to other organizations. Coaching program 208 may rank certain goals that may need longer lead times so that they are started early in the quarter. Coaching program 208 may also have components for management to approve such quarterly goals and plan. Once finalized, coaching program 208 executes the coaching protocol and guides and coaches the employee to meet the goals.

Coaching program 208 may frequently survey user 102 on how the user is doing in regards to the goals in the plan. Coaching program 208 can escalate issues to management as targets are missed and an opportunity of goals not being met develops.

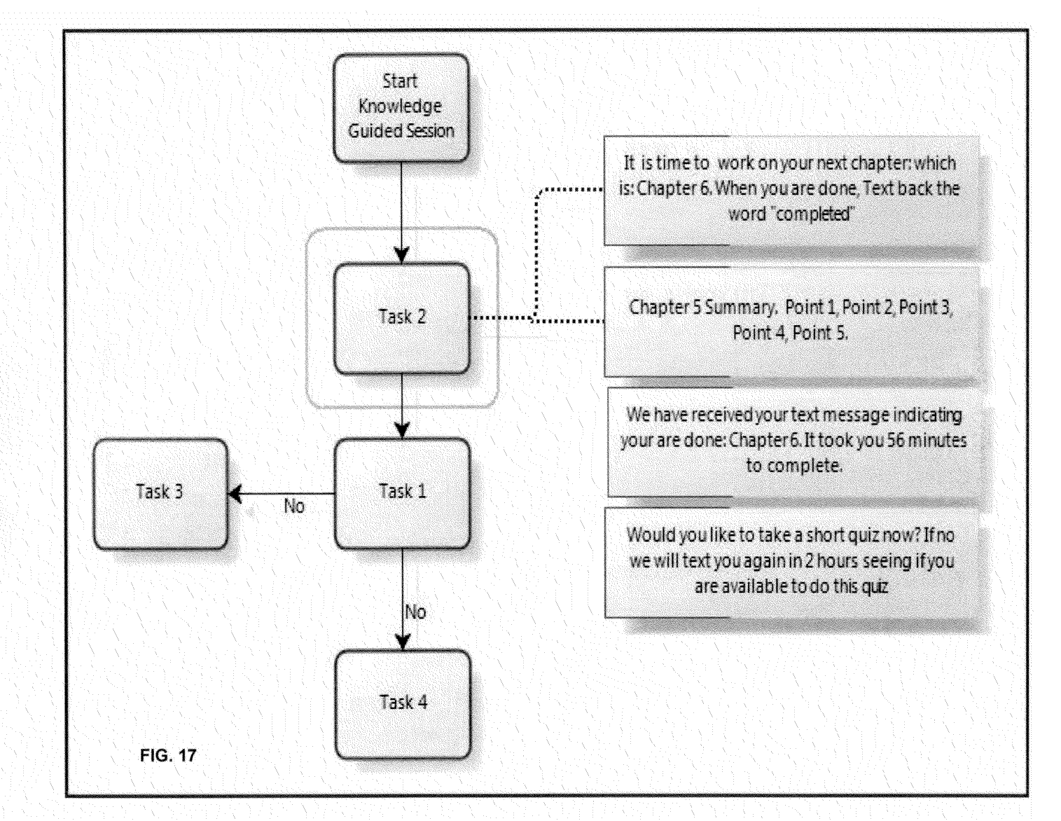

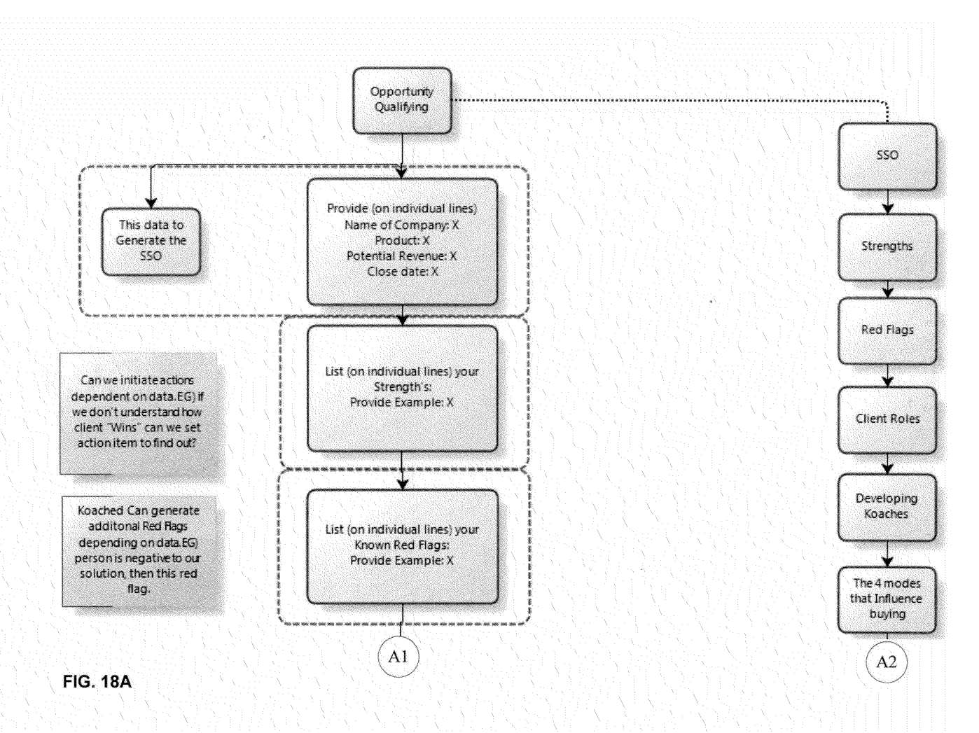

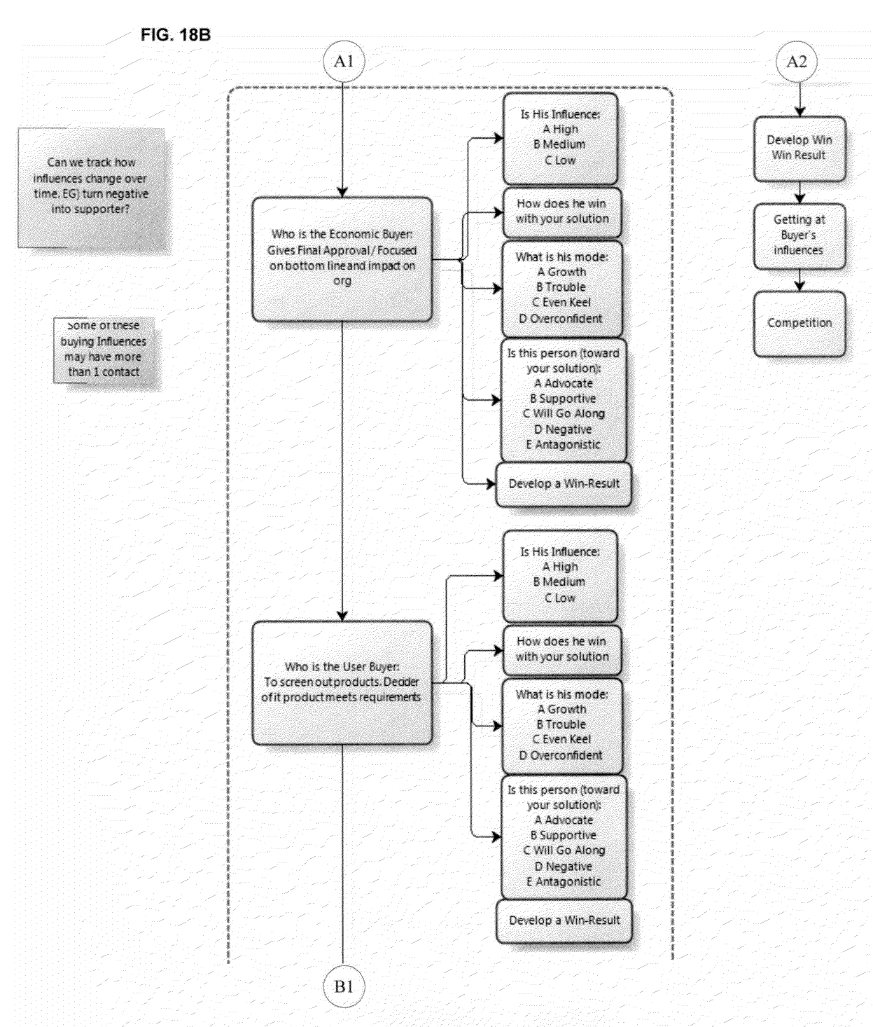

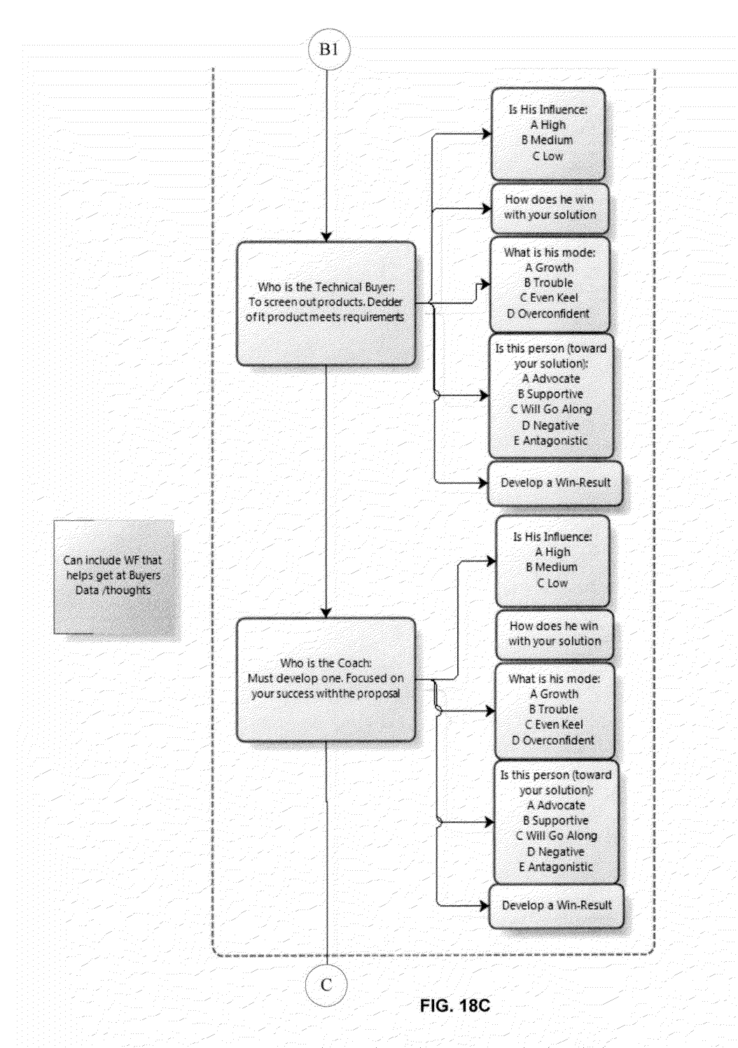

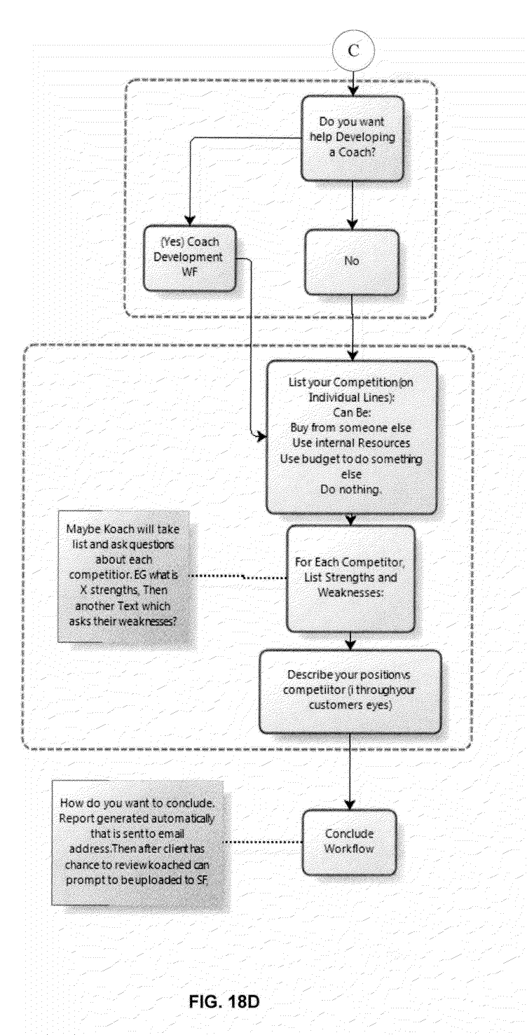

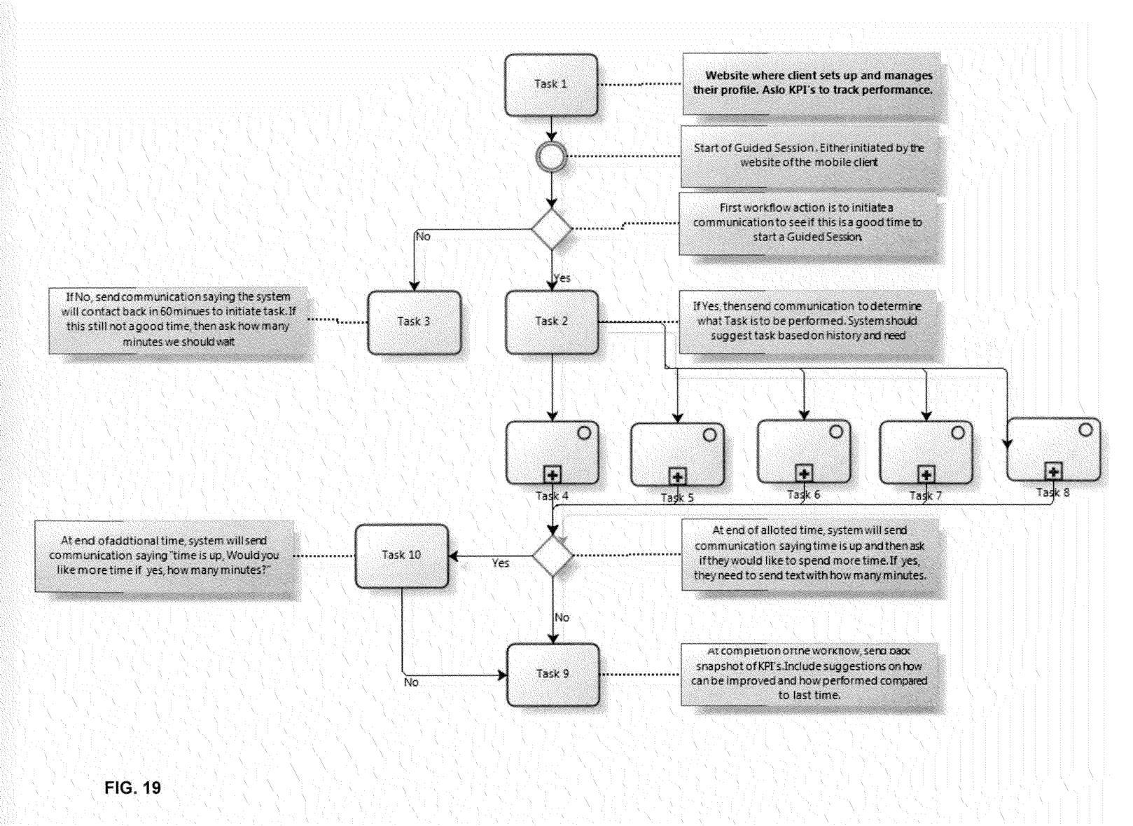

As is obvious from the above examples, the coaching system 108 and coaching program 208 are very flexible systems that can implement and execute various coaching protocols for various purposes and settings. Yet more examples of such coaching protocols may be found in FIGS. 17, 18A-D, and 19.

As is inherent in the above description, coaching system 108 and coaching program 208 together with the protocols may be provided by a business or an individual to other organizations or individuals. Such a business may license system 108 and program 208 in its entirety for limited and/or unlimited time and/or purposes. For example, a business may install system 108 and coaching program 208 at a client site, may itself run system 108 and coaching program 208 and license their use to clients, or may use other combination to provide such automated coaching as described herein. Clients may be individuals or private and public organizations interested in having their employees or members coached by coaching system 108 and coaching program 208.

It should be appreciated that one implementation of the present invention comprises a computer readable medium (e.g., a computer memory, a floppy disk, a compact disk, a tape, etc.) encoded with a computer program that, when executed on a processor, performs the above discussed functions of the various embodiments described above. The computer readable medium can be transportable such that the program stored thereon can be loaded onto a computer system (one or more host computer systems or general purpose processors associated with the backup storage systems) to implement the aspects of the various embodiments described above. In addition, it should be appreciated that the reference to a computer program that, when executed, performs the above discussed functions is not limited to an application program running in an application space on the host computer. Rather, the term “computer program” is used herein in a generic sense to reference any type of computer code (e.g., software or microcode) that can be employed to program a processor to implement the various embodiments described above.

Having described several embodiments in detail, various modifications and improvements will readily occur to those skilled in the art. Such modifications and improvements are intended to be within the spirit and scope of the invention. Accordingly, the foregoing description is by way of example only and is not intended as limiting. The invention is limited only as defined by the following claims and the equivalents thereto.

What is claimed is:

1. A computer-implemented method comprising:
accessing a coaching protocol for coaching a person in real-time to engage in a predetermined behavior;
sending in real-time a message to the person to execute the one of the plurality of behavior-steps;
wherein the coaching protocol comprises a plurality of behavior-steps, wherein the execution of one of the plurality of behavior-steps by the person results in the person engaging in the predetermined behavior.

2. The method of claim 1 further comprising:
gathering data;
determining, based on the gathered data, whether to modify the coaching protocol.

3. The method of claim 2 further comprising:
modifying, based on the determining step, the coaching protocol.

4. The method of claim 3 further comprising:
sending in real-time a second message to the person to execute a second one of the plurality of behavior-steps selected from the modified coaching protocol.

5. The method of claim 4 further comprising:
receiving a message from the person prior to the sending of the second message, wherein the second message is sent in response to the received message from the person;
selecting, based on the response, the second one of the plurality of behavior-steps from the modified coaching protocol to be executed next by the person.

6. The method of claim 4 wherein the received message from the person comprises information regarding the execution of the one of the plurality of behavior-steps.

7. The method of claim 3 wherein the step of modifying the coaching protocol includes modifying the second one of the plurality of behavior-steps.

8. The method of claim 3 wherein the step of modifying the coaching protocol includes adding a new step to the plurality of behavior-steps.

9. The method of claim 1 wherein the coaching protocol further comprises another plurality of behavior-steps for execution by at least one other person, the method further comprising:
sending in real-time at least one other message to the at least one other person to execute one of the another plurality of behavior-steps.

10. The method of claim 9 wherein execution of one of the plurality of behavior-steps by the person and the execution of the another plurality of behavior-steps by the at least one other person results in execution of the predetermined behavior by the person and the at least one other person.

11. The method of claim 9 wherein the step of sending in real-time the at least one other message is performed after receiving a message from the person and determining based on the message from the person whether to send the at least one other message.

12. The method of claim 1 further comprising:
receiving information on the predetermined behavior; and
generating, based on the data, the coaching protocol.

13. The method of claim 12 where in the generating step further comprises:
selecting, based on the information on the predetermined behavior, among sets of predefined behavior-steps, at least one set of behavior-steps to generate the coaching protocol.

14. The method of claim 13 wherein the generating step further comprises:
receiving information defining at least one behavior step to be included in the coaching protocol.

15. The method of claim 14 wherein the receiving step further comprises:
presenting a question in response to which the information is received.

16. The method of claim 1 wherein the message is a text message sent over a network.

17. The method of claim 1 where the in the message is an automated telephone call.

18. The method of claim 1 wherein the message includes a query, the method further comprising:
receiving data from the person;
parsing the data to determine a response of the person to the query.

19. The method of claim 18 wherein the message includes at least one predefined response to the query and the parsing step comprises:
analyzing the data to detect the predefined response.

20. The method of claim 19 further comprising:
determining, based on the response, whether to notify at least one other person.

21. The method of claim 1 wherein the coaching protocol is generated based on information regarding a sales opportunity.

22. The method of claim 1 where wherein the coaching protocol is generated based on information regarding periodic goals for the individual.

23. The method of claim 1 where wherein the coaching protocol is generated based on information regarding compliance with a legal regulatory regime.

24. A computer-implemented method comprising:
accessing a coaching protocol for coaching a person to engage in a predetermined behavior, wherein the coaching protocol comprises a plurality of behavior-steps, wherein the execution of one of the plurality of behavior-steps by the person results in the person engaging in the predetermined behavior;
sending in real-time a message to the person to execute the one of the plurality of behavior-steps;
gathering data;
determining, based on the gathered data, whether to modify the coaching protocol; and
modifying the coaching protocol, if it is determined in the determining step to modify the coaching protocol.

25. A computer system comprising:
means for accessing a coaching protocol for coaching a person in real-time to engage in a predetermined behavior;
means for sending in real-time a message to the person to execute the one of the plurality of behavior-steps;
wherein the coaching protocol comprises a plurality of behavior-steps, wherein the execution of one of the plurality of behavior-steps by the person results in the person engaging in the predetermined behavior.

26. A computer system comprising at least one processor and a machine readable medium storing a computer program, wherein the computer program comprises machine-readable instructions for the computer system to execute a computer-implemented method comprising:
accessing a coaching protocol for coaching a person in real-time to engage in a predetermined behavior comprising a plurality of behavior-steps;
sending in real-time a message to the person to execute the one of the plurality of behavior-steps;
wherein the coaching protocol comprises a plurality of behavior-steps, wherein the execution of one of the plurality of behavior-steps by the person results in the person engaging in the predetermined behavior.

27. A machine-readable medium storing a computer program comprising machine-readable instructions for a computer system to execute a computer-implemented method comprising:
accessing a coaching protocol for coaching a person in real-time to engage in a predetermined behavior;
sending in real-time a message to the person to execute the one of the plurality of behavior-steps;
wherein the coaching protocol comprises a plurality of behavior-steps, wherein the execution of one of the plurality of behavior-steps by the person results in the person engaging in the predetermined behavior.

28. A computer implemented method comprising:
transmitting over a network computer program comprising machine-readable instructions for a computer system to execute a computer-implemented method comprising:
accessing a coaching protocol for coaching a person in real-time to engage in a predetermined behavior;
sending in real-time a message to the person to execute the one of the plurality of behavior-steps;
wherein the coaching protocol comprises a plurality of behavior-steps, wherein the execution of one of the plurality of behavior-steps by the person results in the person engaging in the predetermined behavior.
